(19) United States
(12) Patent Application Publication
(10) Pub. No.: US 2025/0285580 A1
(43) Pub. Date: Sep. 11, 2025

(54) DISPLAY DRIVING CIRCUIT, AND OPERATION METHOD OF THE DISPLAY DRIVING CIRCUIT

(71) Applicant: Samsung Electronics Co., Ltd., Suwon-si (KR)

(72) Inventors: Sunkwon Kim, Suwon-si (KR); Taehyeon Kwon, Suwon-si (KR); Kangjoo Kim, Suwon-si (KR); Yongil Kwon, Suwon-si (KR); Hyunwook Lim, Suwon-si (KR)

(21) Appl. No.: 19/070,469

(22) Filed: Mar. 4, 2025

(30) Foreign Application Priority Data
Mar. 7, 2024 (KR) 10-2024-0032843
Aug. 30, 2024 (KR) 10-2024-0117939

(51) Int. Cl. G09G 3/32

(52) U.S. Cl. CPC G09G 3/32; G09G 2300/0814; G09G 2300/0857; G09G 2310/0267; G09G 2310/0275; G09G 2310/04; G09G 2310/08; G09G 2330/021

(57) ABSTRACT

A display driving circuit includes a pixel circuit array including a plurality of pixel circuits arranged in a matrix, each of the plurality of pixel circuits storing received pixel data and providing a driving current corresponding to the pixel data to an emission device, an interface circuit configured to receive a partial update command and partial update data from a host, a row driving circuit configured to provide write clock signals to first pixel circuits included in one or more update row of the pixel circuit array, based on a update area signal generated based on update area information included in the partial update command, and a data driving circuit configured to provide update pixel data to each of the update pixel circuits among the first pixel circuits, based on the partial update data.

### CROSS-REFERENCE TO RELATED APPLICATION(S)

This application is based on and claims priority under 35 U.S.C. § 119 to Korean Patent Application No. 10-2024-0032843, filed on Mar. 7, 2024, and Korean Patent Application No. 10-2024-0117939, filed on Aug. 30, 2024, in the Korean Intellectual Property Office, the disclosure of each of which is incorporated by reference herein in its entirety.

### BACKGROUND

The inventive concept relates to semiconductor devices, and more particularly, to a display driving circuit included in a display device, and an operation method of the display driving circuit.

As the information society develops, the demand for display devices that display images is increasing, and various types of display devices such as liquid crystal display (LCD) devices, plasma display devices, and organic light-emitting display devices are being used. In particular, interest in display devices using micro light-emitting diodes (μLEDs) has been increasing recently.

As improvements in the characteristics of display devices are demanded to implement virtual reality (VR), augmented reality (AR), and mixed reality (MR) technologies, the development of a micro LED on a semiconductor wafer or an active matrix-type organic light-emitting diode (AMOLED) on a semiconductor wafer is increasing. A method of reducing power consumption of a display device and a method of reducing the size of a driving circuit that drives a pixel array are being researched.

### SUMMARY

The inventive concept provides a display driving circuit capable of updating a partial area of a display without a frame memory, and an operation method of the display driving circuit.

According to an aspect of the inventive concept, there is provided a display driving circuit including a pixel circuit array including a plurality of pixel circuits arranged in a matrix, each of the plurality of pixel circuits storing received pixel data and providing a driving current corresponding to the pixel data to an emission device, an interface circuit configured to receive a partial update command and partial update data from a host processor, a control logic configured to generate a first update area signal indicating at least one update row including update pixel circuits to which the pixel data is to be updated from among a plurality of rows of the pixel circuit array, based on update area information included in the partial update command, a row driving circuit configured to provide write clock signals to first pixel circuits included in the at least one update row of the pixel circuit array, based on the first update area signal, and a data driving circuit configured to provide update pixel data to each of the update pixel circuits from among the first pixel circuits, based on the partial update data.

According to another aspect of the inventive concept, there is provided a display driving circuit for driving a pixel array that displays an image, the display driving circuit including an interface circuit configured to receive commands and image data from a host processor, receive a first command of the commands and first frame data corresponding to a first image of one frame of the image data in a first frame period, and receive a second command of the commands and partial update data corresponding to a partial area of a second image of one frame of the image data in a second frame period, a row driving circuit configured to enable at least one update row from among a plurality of rows of the pixel array during a data write period of the second frame period, and a data driving circuit configured to provide the partial update data to at least one update column from among a plurality of columns of the pixel array, based on the partial update data during the data write period of the second frame period.

According to another aspect of the inventive concept, there is provided an operation method of a display driving circuit for driving a pixel array that displays an image, the operation method including fully updating frame data stored in the pixel array with first frame data corresponding to a first image, based on a first command received from a host processor and the first frame data, during a data write period of a first frame period, and partially updating frame data stored in the pixel array with partial update data, based on a second command received from the host processor and the partial update data, during a data write period of a second frame period. The partially updating of the frame data includes receiving the partial update data in at least one horizontal period from among a plurality of horizontal periods in the data write period of the second frame period, and writing the partial update data to at least one update row of a plurality of rows of the pixel array during the at least one horizontal period.

### BRIEF DESCRIPTION OF THE DRAWINGS

Embodiments will be more clearly understood from the following detailed description taken in conjunction with the accompanying drawings in which:

FIG. 1 is a block diagram of a display system according to an example embodiment;

FIG. 2 is a schematic block diagram of a display device according to an example embodiment;

FIG. 3 is a view of a pixel array of FIG. 1 according to an example embodiment;

FIG. 4 shows one frame period according to an operation of a display device according to an embodiment;

FIGS. 5A, 5B, and 5C are views illustrating operations of the display device based on modes, according to example embodiments;

FIG. 6A illustrates a full image mode operation of the display device, according to an example embodiment;

FIG. 6B illustrates N-th frame data and (N+1)th frame data according to an example embodiment;

FIG. 7 illustrates a partial update mode operation of the display device according to a transmission method, according to example embodiments;

FIG. 8 is a schematic diagram of a display device according to an example embodiment;

FIG. 9 illustrates a pixel according to an example embodiment;

FIG. 10A illustrates a display device according to an example embodiment;

FIG. 10B illustrates a data driving circuit of FIG. 10B according to an example embodiment;

FIGS. 11A and 11B are circuit diagrams of pixel circuits according to example embodiments;

FIG. 12 is a flowchart of an operation method of a display device, according to an example embodiment;

FIG. 13 is a schematic view illustrating a process of manufacturing a display device, according to an example embodiment; and

FIGS. 14A and 14B are schematic views of a head-mounted display to which a display device is applied, according to example embodiments.

### DETAILED DESCRIPTION OF THE EMBODIMENTS

Hereinafter, various embodiments will be described below with reference to accompanying drawings.

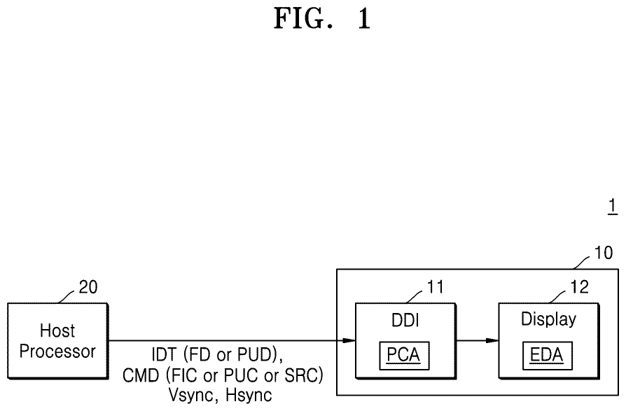

FIG. 1 is a block diagram of a display system 1 according to an example embodiment.

The display system 1 may be mounted on an electronic device that displays images. For example, the electronic device may be any one of a smartphone, a tablet personal computer (PC), an e-book reader, a desktop PC, a laptop PC, a netbook computer, a portable multimedia player (PMP), an MP3 player, a mobile medical device, a camera, a wearable device (e.g. a head-mounted-device (HMD) such as electronic glasses, electronic clothing, an electronic bracelet, an electronic necklace, an electronic appcessory, or a smart watch), a virtual reality (VR) device, an augmented reality (AR) device, and a mixed reality (MR) device.

Referring to FIG. 1, the display system 1 may include a display device 10 and a host processor 20, and the display device 10 may include a display driving integrated circuit, a display driver integrated circuit, or a display driving circuit (DDI) 11 and a display 12.

The host processor 20 may control overall operations of the display device 10. According to an embodiment, the host processor 20 may be implemented as a main processor of the electronic device on which the display system 1 is mounted. According to an embodiment, the host processor 20 may be implemented as an application processor (AP) of a mobile electronic device.

The host processor 20 may generate image data IDT and a command CMD corresponding to an image that is to be displayed on the display 12, and may transmit the image data IDT and the command CMD to the display driving circuit 11 of the display device 10. The host processor 20 may also generate synchronization signals, such as a vertical synchronization signal Vsync and a horizontal synchronization signal Hsync, and transmit the synchronization signals to the display driving circuit 11.

According to an embodiment, the host processor 20 and the display driving circuit 11 may transmit and receive data therebetween, based on a high-speed interface method. For example, a mobile industry processor interface (MIPI) method is applicable as a data communication method between the host processor 20 and the display driving circuit 11. However, embodiments are not limited thereto, and one of high-speed serial interface methods, such as mobile display digital interface (MDDI), an RGB interface, a mobile pixel link (MPL), and a serial peripheral interface (SPI), may be applied to the data communication method between the host processor 20 and the display driving circuit 11.

The host processor 20 may transmit, to the display driving circuit 11, frame data FD corresponding to one frame of the image to be displayed on the display 12 or partial update data PUD corresponding to a partial area of the one frame of the image as the image data IDT.

The frame data FD may include a plurality of pieces of pixel data respectively corresponding to a plurality of pixels (or a plurality of emission devices) of the display 12. The host processor 20 may transmit the frame data FD together with a full image command FIC and the synchronization signals to the display driving circuit 11.

The partial update data PUD may include pixel data of a partial area among the frame data FD. For example, when a video is displayed on the display 12, there may be a difference in some areas between an image of a current frame (e.g., an N-th frame, where N is a positive integer) displayed on the display 12 and an image of a next frame (e.g., an (N+1)th frame) that is to be displayed on the display 12. When there is a difference in some areas between the image of the current frame and the image of the next frame, the host processor 20 may transmit, to the display driving circuit 11, partial update data corresponding to a partial area of next frame data (e.g., (N+1)th frame data) corresponding to the image of the next frame, rather than the entirety of the next frame data.

The host processor 20 may transmit the partial update data PUD together with a partial update command PUC and the synchronization signals to the display driving circuit 11. The partial update command PUC may include mode information indicating a partial update mode, and update area information indicating an area in which pixel data is updated based on the partial update data PUD on the display 12. According to an embodiment, the host processor 20 may transmit the partial update data PUD to the display driving circuit 11 according to one of various transmission methods, and the partial update command PUC may further include information indicating a transmission method.

When the image of the current frame is identical to the image of the next frame, the host processor 20 may transmit a self-refresh command SRC indicating a self-refresh mode to the display driving circuit 11, without transmitting the image data IDT and the synchronization signals to the display driving circuit 11.

The display driving circuit 11 may display an image on the display 12 in units of frames, based on the image data IDT, the command CMD, and the synchronization signals received from the host processor 20.

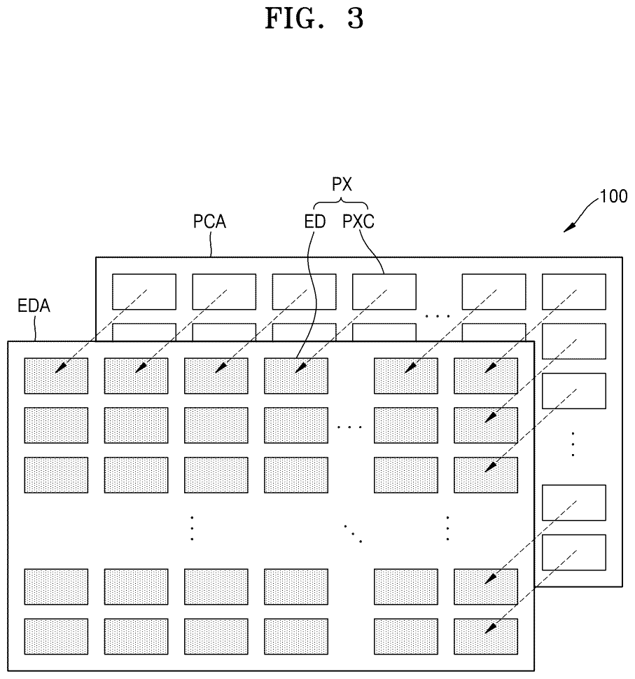

The display 12 may be implemented as an emission device array EDA including a plurality of emission devices (e.g., an emission device ED of FIG. 3) arranged in a matrix. The display 12 may be a light-emitting diode (LED) display implemented with LEDs, and may be implemented as a flat panel display or a flexible display. For example, the display 12 may be an LED display implemented with an LED having a size of 100 micrometers (μm) or less (i.e., a micro LED). However, the present invention is not limited thereto, and the display 12 may be implemented as another type of display, such as an organic LED (OLED) display, an active-matrix OLED (AMOLED) display, a liquid crystal display (LCD), a digital mirror device (DMD), or an actuated mirror device (AMD).

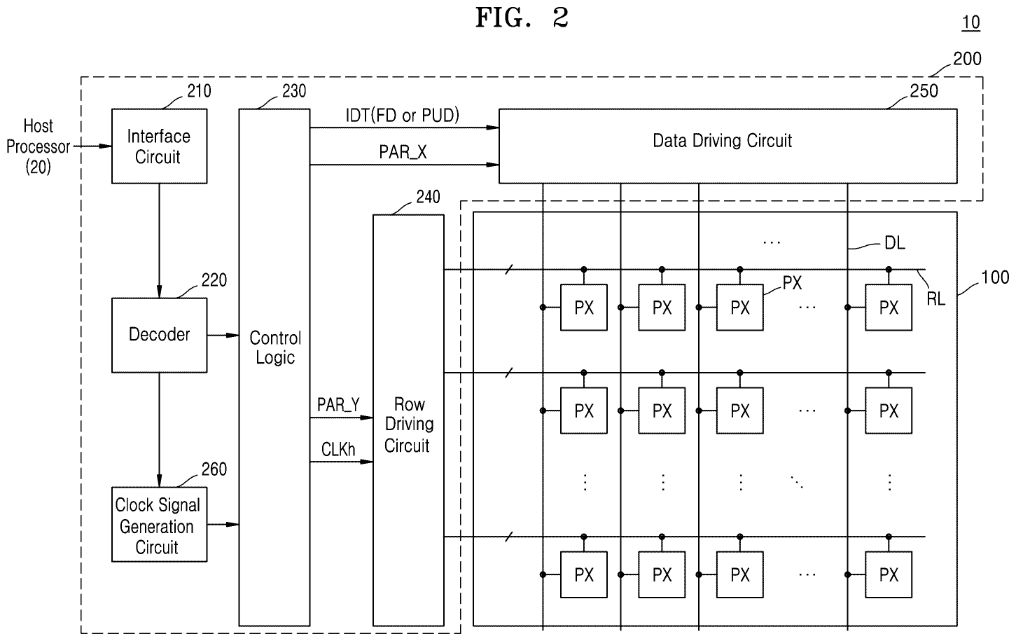

The display driving circuit 11 may include a pixel circuit array PCA, and the pixel circuit array PCA may include a plurality of pixel circuits PXC of FIG. 3 that are arranged in a matrix and respectively correspond to the plurality of emission devices ED of the emission device array EDA. The pixel circuit array PCA may be combined with the emission device array EDA to implement a pixel array (e.g., a pixel array 100 of FIG. 2) including a plurality of pixels (e.g., pixels PX of FIG. 2), and each of the plurality of pixels PX may include a pixel circuit and an emission device.

The pixel circuit array PCA may store the frame data FD. Each of the plurality of pixel circuits of the pixel circuit array PCA may store pixel data of the frame data FD, and may provide a driving signal, such as a driving current, corresponding to the stored pixel data to a corresponding emission device among the plurality of emission devices. Accordingly, an image of one frame corresponding to the frame data FD stored in the pixel circuit array PCA may be displayed on the display 12. Hereinafter, in the inventive concept, writing (or storing) the frame data FD or the partial update data PUD to the pixel array 100 may refer to writing (or storing) the frame data FD or the partial update data PUD to (or in) the pixel circuit array PCA, and writing (or storing) pixel data to (or in) a pixel PX may refer to writing (or storing) pixel data to a pixel circuit PXC.

When the display driving circuit 11 receives the full image command FIC and the frame data FD from the host processor 20, the display driving circuit 11 may store the received frame data FD in the pixel circuit array PCA. Frame data FD stored in the pixel circuit array PCA in a previous frame period may be updated with frame data FD received in a current frame period. For example, pixel data of all of the plurality of pixel circuits of the pixel circuit array PCA may be updated (e.g., full updated). The display 12 may display an image corresponding to the frame data FD received in the current frame period.

The display driving circuit 11 may perform a partial update operation when the partial update command PUC and the partial update data PUD are received from the host processor 20. The display driving circuit 11 may update pixel data (e.g., partial update) to some pixel circuits (e.g., pixel circuits to which pixel data is to be updated) according to update area information of the partial update command PUC from among the plurality of pixel circuits of the pixel circuit array PCA, based on the partial update data PUD. Other pixel circuits may retain pixel data stored in the previous frame period. Accordingly, the display 12 may display an image in which a portion corresponding to the partial update data PUD in the image displayed in the previous frame period has been changed.

When the self-refresh command SRC is received from the host processor 20, the display driving circuit 11 may perform a self-refresh operation. The circuit array PCA may maintain (e.g., self-refresh) the frame data FD stored in the previous frame period and provide driving signals corresponding to the frame data FD to the emission device array EDA. The display 12 may display an image that is the same as the image displayed in the previous frame period.

In the display system 1 according to an embodiment, when there is a difference in some areas between the image of the current frame displayed on the display 12 and the image of the next frame to be displayed on the display 12, the host processor 20 may transmit, to the display driving circuit 11, the partial update data PUD and the partial update command PUC corresponding to some area of frame data other than the frame data corresponding to the image of the next frame. In addition, when the image of the current frame is the same as the image of the next frame, the host processor 20 may not transmit the image data IDT to the display driving circuit 11, but may transmit, to the display driving circuit 11, the self-refresh command SRC indicating that an image corresponding to previously-stored frame data is to be displayed by using the previously-stored frame data.

Accordingly, the amount of data transmitted between the host processor 20 and the display driving circuit 11 may be reduced, and, during a period in which data is not transmitted between the host processor 20 and the display driving circuit 11, a transmission interface circuit of the host processor 20 (e.g., a circuit that transmits data to the display driving circuit 11) and a reception interface circuit of the display driving circuit 11 (e.g., a circuit that receives data from the host processor 20) may operate in a low power mode. For example, an operating current, an operating voltage, or an operating frequency of each of the transmission interface circuit and the reception interface circuit may be reduced (or blocked). Accordingly, power consumption of the host processor 20 and the display device 10 may be reduced.

Moreover, because the display driving circuit 11 may perform a partial update operation or a self-refresh operation without including a frame memory, the size of the display driving circuit 11 may be reduced.

FIG. 2 is a schematic block diagram of the display device 10 according to an example embodiment. The display device 10 of FIG. 2 may be applied to the display system 1 of FIG. 1. Accordingly, the display device 10 will now be described with reference to FIG. 2 together with FIG. 1.

Referring to FIG. 2, the display device 10 may include the pixel array 100 and a driving circuit 200. As illustrated in FIG. 3, the pixel array 100 may be implemented by combining the emission device array EDA with the pixel circuit array PCA, and the pixel circuit array PCA and the driving circuit 200 may be included in the display driving circuit 11 of FIG. 1.

The pixel array 100 may include a plurality of pixels PX, and may display an image in units of frames. The plurality of pixels PX may be arranged in any of various patterns, such as a matrix, a zigzag, and others. For example, the plurality of pixels PX may be arranged in a matrix.

The pixel array 100 may further include a plurality of row lines RL (or referred to as scan lines) each extending in a row direction and a plurality of data lines DL each extending in a column direction. Each of the plurality of pixels PX may be connected to one of the row lines RL and one or more data lines DL. The pixel array 100 may include a plurality of rows and a plurality of columns, each of the plurality of rows including pixels PX connected to the same row line RL and each of the plurality of columns including pixels PX connected to the same data line DL. The pixel array 100 may receive row control signals through the row lines RL, and may receive pixel data through one or more data lines DL.

According to an embodiment, the pixel array 100 may further include a plurality of mask bit lines each extending in the column direction, and each of the plurality of pixels PX may receive a mask bit through a mask bit line. The mask bit indicates whether to update the pixel data of the pixel PX. For example, a pixel PX may update pixel data by receiving and storing pixel data received via a data line DL in response to a mask bit of a first level (e.g., logic low), and, in response to a mask bit of a second level (e.g., logic high), may not update pixel data and may maintain previously-stored pixel data by not receiving the pixel data.

The pixel PX may output (emit) an optical signal corresponding to the pixel data, and the optical signal may be, for example, an optical signal of one of red, blue, and green colors. A red pixel outputting a red optical signal, a blue pixel outputting a blue optical signal, and a green pixel outputting a green optical signal may be repeatedly arranged, and a red pixel, a blue pixel, and a green pixel may constitute one unit pixel. However, embodiments are not limited thereto, and the pixel PX may output optical signals of other colors than red, blue and green colors. A unit pixel may be implemented with pixels of a plurality of different colors.

FIG. 3 is a view of the pixel array 100 of FIG. 2 according to an example embodiment. Referring to FIG. 3, the emission device array EDA may be combined with the pixel circuit array PCA to be implemented as the pixel array 100. The emission device array EDA may include a plurality of emission devices ED arranged in a matrix. The pixel circuit array PCA may include a plurality of pixel circuits PXC each connected to a corresponding emission device ED among the plurality of emission devices ED. The plurality of pixel circuits PXC may be connected to a plurality of row lines RL of FIG. 2 and a plurality of data lines DL of FIG. 2. Each of the plurality of pixels PX includes an emission device ED and a pixel circuit PXC.

The emission device ED may output an optical signal according to the driving current provided by the pixel circuit PXC. For example, the emission device ED may be a self-emission device. For example, the emission device ED may be an LED. The emission device ED may be an LED having a micro-size to a nanoscale size. The emission device ED may emit light of a single peak wavelength or may emit light of a plurality of peak wavelengths. For example, the emission device ED may be an OLED. However, the present invention is not limited thereto, and any of various other types of devices may be implemented as the emission device ED.

The pixel circuit PXC may store pixel data received through a data line DL, and may provide a driving current to an emission device ED, based on the pixel data. The pixel circuit PXC may include a storage circuit for storing the pixel data. For example, the storage circuit may include a flip flop or a latch. The storage circuit may include memory circuits such as memory cells of a static random access memory (SRAM).

The pixel circuit PXC may control a luminance of an optical signal output by the emission device ED, by controlling the amount of driving current or the period during which the driving current is provided, based on the pixel data. For example, the pixel circuit PXC may control a luminance of the emission device according to a pulse width modulation (PWM) driving method, based on the pixel data. For example, the pixel PX may control the luminance of the emission device according to a pulse amplitude modulation (PAM) method of changing an intensity of the driving current flowing in the emission device ED, based on the pixel data. For example, a pixel PX may control the luminance of an emission device according to a method in which a PAM method is mixed with a PWM method.

The pixel data may include a plurality of bits, and a value represented by the pixel data (hereinafter, referred to as a pixel data value) may represent a gradation corresponding to a combination of bit values. For example, when the pixel data includes n bits (where n is an integer of 2 or greater), the value of the pixel data (e.g., a combination of bit values of the n bits) may represent one of 2ⁿ gradations. The luminance of the emission device may correspond to a gradation indicated by the value of the pixel data.

Referring to FIG. 2, the driving circuit 200 (or referred to as a pixel array driving circuit) may drive and control the pixel array 100. The driving circuit 200 may include an interface circuit 210, a decoder 220, a control logic 230, a row driving circuit 240, a data driving circuit 250, and a clock signal generation circuit 260.

The interface circuit 210 may receive the command CMD, the image data IDT, and the synchronization signals from an external processor, such as the host processor 20 of FIG. 1. For example, the synchronization signals may include a vertical synchronization signal Vsync and a horizontal synchronization signal Hsync.

The interface circuit 210 may receive the frame data FD together with the full image command FIC. The interface circuit 210 may receive the partial update data PUD together with the partial update command PUC. The interface circuit 210 may receive a self-refresh command SRC. When the interface circuit 210 receives a self-refresh command SRC, the image data IDT may be not received.

The interface circuit 210 may provide data (e.g., the command CMD, the image data IDT, and the synchronization signals) externally received from the host processor 20 to the decoder 220, and the decoder 220 may decode (or decompress) the received data. In order to reduce the amount of data transmitted and received between the processor 210 and the interface circuit 210, the host processor 20 may encode (or compress) data that is to be transmitted to the interface circuit 210, and may transmit the coded data to the interface circuit 210. Therefore, the decoder 220 may decode the command CMD, the image data IDT, and the synchronization signal by decoding the data received from the host processor 20.

The control logic 230 may receive the command CMD, the image data IDT, and the synchronization signals from the decoder 220, and, based on them, may control the row driving circuit 240 and the data driving circuit 250 to drive the pixel array 100. For example, the control logic 230 may receive the decoded command CMD, the decoded image data IDT, and the decoded synchronization signals from the decoder 220. The control logic 230 may generate control signals for controlling the row driving circuit 240 and the data driving circuit 250, and provide the control signals to the row driving circuit 240 and the data driving circuit 250. For example, the control signals may include one or more timing control signals and/or setting control signals that control an operation timing of each of the row driving circuit 240 and the data driving circuit 250.

The control logic 230 may provide the image data IDT (e.g., the frame data FD or the partial update data PDT) to the data driving circuit 250 in units of row data. The row data includes pixel data of one row corresponding to pixels PX of one row of the pixel array 100 among a plurality of pieces of pixel data of the image data IDT.

According to an embodiment, the control logic 230 may receive internal synchronization signals from the clock signal generation circuit 260, and may use the internal synchronization signals as the synchronization signals.

The clock signal generation circuit 260 may internally generate the internal synchronization signals, such as an internal vertical synchronization signal and/or an internal horizontal synchronization signal, and provide the internal synchronization signals to the control logic 230. According to an embodiment, the clock signal generation circuit 260 may be implemented as an oscillator.

The clock signal generation circuit 260 may generate the internal vertical synchronization signal and the internal horizontal synchronization signal, based on the vertical synchronization signal Vsync and/or the horizontal synchronization signal Hsync received from the host processor 20. For example, the clock signal generation circuit 260 may detect a period (or frequency) of each of the vertical synchronization signal Vsync and/or the horizontal synchronization signal Hsync received from the host processor 20, and may generate the internal vertical synchronization signal and/or the internal horizontal synchronization signal, based on the detected periods (or frequencies), or calibrate the period (or frequency) of the internal vertical synchronization signal and/or the internal horizontal synchronization signal.

The row driving circuit 240 and the data driving circuit 250 may drive the pixel array 100, based on the control signals provided by the control logic 230 and the image data IDT. The row driving circuit 240 and the data driving circuit 250 may drive the pixel array 100 so that the pixel array 100 may store (write) the image data IDT (frame data FD or partial update data PDT) during a data write period, and may drive the pixel array 100 so that the pixel array 100 may display an image, based on the stored frame data FD during an emission period.

The row driving circuit 240 may generate row control signals for driving (or enabling or activating) the plurality of pixels PX of the pixel array 100 in units of rows. For example, the row control signals may include write clock signals, output clock signals, an output enable signal, and/or a self-refresh signal. The row driving circuit 240 may provide row control signals to the plurality of pixels PX in units of rows through the plurality of row lines RL.

The row driving circuit 240 may sequentially drive (enable) a plurality of rows or some rows of the pixel array 100 during the data write period. Pixels PX included in an enabled row may store received pixel data.

The row driving circuit 240 may sequentially drive the plurality of rows of the pixel array 100 so that the plurality of pixels PX of the pixel array 100 may output optical signals based on the stored pixel data during the emission period. Each of the plurality of rows of the pixel array 100 may be connected to row lines RL, and the row driving circuit 240 may provide row control signals to each of the plurality of rows through the row lines RL. For example, the row driving circuit 240 may provide output clock signals and output enable signals to each of the plurality of rows of the pixel array 100.

The data driving circuit 250 may output row data received from the control logic 230, through the plurality of data lines DL during the data write period. Pixel data of one row included in the row data may be output in parallel (or simultaneously) to the pixel array 100 through the plurality of data lines DL. For example, each of the plurality of columns of the pixel array 100 may be connected to one data line DL, and a plurality of bits (e.g., n bits) of the pixel data may be serially output through one data line DL. For example, each of the plurality of columns of the pixel array 100 may be connected to two or more (e.g., n) data lines DL, and the plurality of bits (e.g., n bits) of the pixel data may be output through two or more data lines DL in parallel with each other.

The plurality of pixels PX of the pixel array 100 may store the pixel data received in the pixel circuit PXC during the data write period, generate a driving signal corresponding to the pixel data stored, and provide the generated driving signal to the emission device ED, during the emission period. The plurality of emission devices ED included in the plurality of pixels PX, for example, the emission device array EDA, output optical signals, based on received driving signals, during an emission period, and thus an image may be displayed.

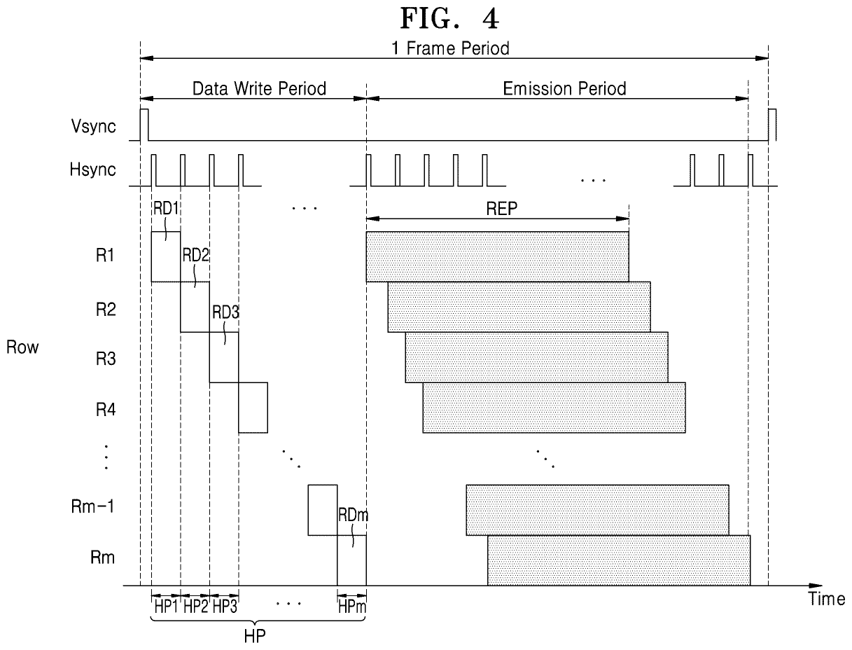

FIG. 4 shows one frame period according to an operation of the display device 10 according to an example embodiment. This will now be described with reference to FIGS. 1 and 3.

A frame period may include a data write period and an emission period. The frame period may further include a rest period after the emission period and before a next frame period. The frame period may be distinguished by the vertical synchronization signal Vsync received from the host processor 20 or the internal vertical synchronization signal generated from the clock signal generation circuit 260. For example, a period from when the vertical synchronization signal Vsync is received (or toggled) to when a next vertical synchronization signal Vsync is received may correspond to one frame period. The data write period and the emission period may be distinguished by the horizontal synchronization signal Hsync received from the host processor 20 or the internal horizontal synchronization signal generated from the clock signal generation circuit 260. For example, the horizontal synchronization signal Hsync may be received after the vertical synchronization signal Vsync is received, and a period until when a predetermine number of horizontal synchronization signals Hsync are received may correspond to the data write period. A period until a predetermined number of horizontal synchronization signals Hsync are further received after the data write period may correspond to the emission period.

During the data write period, the interface circuit 210 may receive the image data IDT, for example, the frame data FD or the partial update data PUD, and the image data IDT may be written to the pixel array 100. The image data IDT may be received sequentially in units of rows (e.g., row data) through the interface circuit 210, and may be written to the pixel array 100.

The data write period may include a plurality of horizontal periods HP, for example, first, second, third, through m-th horizontal periods HP1, HP2, HP3, through HPm, corresponding to a plurality of rows, for example, first, second, third, through m-th rows R1, R2, R3, through Rm (where m is an integer of 2 or greater). For example, the plurality of horizontal periods HP may be distinguished by the horizontal synchronization signal Hsync.

Row data corresponding to a row corresponding to one horizontal period HP may be received from the host processor 20, and may be written to pixels PX of a corresponding row of the pixel array 100. For example, in the first horizontal period HP1, first row data RD1 corresponding to the first row R1 of the pixel array 100 may be received from the host processor 20, and may be written to pixels PX of the first row R1 of the pixel array 100. In the second horizontal period HP2 subsequent to the first horizontal period HP1, second row data RD2 corresponding to the second row R2 of the pixel array 100 may be received from the host processor 20, and may be written to pixels PX of the second row R2 of the pixel array 100. By repeating this process, in the last row period, for example, the m-th horizontal period HPm, m-th row data RDm corresponding to the last row of the pixel array 100, for example, the m-th row Rm of the pixel array 100, may be received from the host processor 20, and may be written to pixels PX of the m-th row Rm of the pixel array 100. For example, the row driving circuit 240 may sequentially drive (enable) the plurality of rows R1 to Rm.

According to an embodiment, when the partial update command PUC and the partial update data PUD are received from the host processor 20, the partial update data PUD may be received in at least one horizontal period among the plurality of horizontal periods HP.

According to an embodiment, for example, when the partial update data PUD includes only the second row data RD2 and the third row data RD3, in the second horizontal period HP2, the second row data RD2 may be received from the host processor 20 and written to pixels PX of the second row R2 of the pixel array 100, and in the third horizontal period HP3, the third row data RD3 may be received from the host processor 20 and written to pixels PX of the third row R3 of the pixel array 100 in the third horizontal period HP3.

According to an embodiment, the second row data RD2 may be received in the first horizontal period HP1 and written to pixels PX of the second row R2 of the pixel array 100, and the third row data RD3 may be received in the second horizontal period HP2 and written to pixels PX of the third row R3 of the pixel array 100.

According to an embodiment, update pixel data among the entire pixel data of the second row data RD2 and update pixel data among the entire pixel data of the third row data RD3 may be received in the first horizontal period HP1 and the second horizontal period HP2, respectively, or may be received in the first horizontal period HP1.

During the emission period, each of the plurality of pixels PX of the pixel array 100 may output an optical signal, based on stored pixel data. Optical signals may be sequentially output from the plurality of rows of the pixel array 100, and emission periods respectively allocated to the plurality of rows, for example, row emission periods REP, may be the same as each other.

Operations of the control logic 230, the row driving circuit 240, and the data driving circuit 250 according to the command CMD during the data write period will now be described with reference to FIG. 2.

When the driving circuit 200 operates in a full image mode (e.g., a normal operation mode) according to the full image command FIC, the row driving circuit 240 may sequentially drive (or enable or activate) the plurality of rows of the pixel array 100 during the plurality of horizontal periods HP under a control by the control logic 230, in the data write period. For example, the row driving circuit 240 may drive (or enable) a corresponding row by providing write clock signals or a write enable signal for data writing through the row lines RL. The row driving circuit 240 may distinguish the plurality of horizontal periods HP from each other or generate write clock signals, based on a horizontal clock signal CLKh received from the control logic 230 or an internal horizontal synchronization signal received from the clock signal generation circuit 260.

The data driving circuit 250 may receive the row data from the control logic 230, and output the row data to the pixel array 100 through the plurality of data lines DL. Each of a plurality of pixels included in an enabled row may store pixel data received through a connected data line DL. Accordingly, the row data may be written to pixels PX of an enabled row of the pixel array 100. The data driving circuit 250 writes the received row data to an enabled row during the plurality of horizontal periods HP so that a plurality of pieces of row data of the frame data FD may be sequentially written to the pixel array 100.

When the driving circuit 200 operates in a partial update mode (e.g., performs a partial update operation) according to the partial update command PUC, the control logic 230 may generate a first update area signal PAR_Y (or referred to as an update row signal) and/or a second update area signal PAR_X (or referred to as an update column signal), based on the update area information of the partial update command PUC in the data write period.

The update area information indicates an area where pixel data is updated in the pixel array 100. For example, the update area information may include coordinates of two pixels PX located at start and end points of a rectangular area corresponding to the update area in the pixel array 100. The coordinates may include row coordinates indicating rows corresponding to the positions of each pixel among the plurality of rows of the pixel array 100 and column coordinates indicating columns corresponding to the positions of each pixel among the plurality of columns of the pixel array 100. For example, the update area information may include the coordinates of a pixel PX located at the start point of the update area and a length of the update area (e.g., the number of pixels PX to be updated). The update area information may also include various pieces of information indicating the update area. According to an embodiment, a plurality of partial areas may be updated in the pixel array 100, and the update area information may include information representing the plurality of partial areas.

The first update area signal PAR_Y indicates at least one row (hereinafter, referred to as an update row) including a pixel PX of which pixel data is to be updated (hereinafter, referred to as an update pixel) from among the plurality of rows of the pixel array 100. The second update area signal PAR_X indicates at least one column including the update pixel (hereinafter, referred to as an update column) from among the plurality of columns of the pixel array 100.

The row driving circuit 240 may drive (or enable) at least one update row of the pixel array 100, based on the first update area signal PAR_Y received from the control logic 230. When there are two or more update rows, the row driving circuit 240 may sequentially drive the update rows during two or more horizontal periods HP.

The row driving circuit 240 may drive (enable) at least one update row by providing write clock signals or the write enable signal to at least one update row from among the plurality of rows of the pixel array 100 during the data write period. The row driving circuit 240 may not drive (or may disable) the other rows excluding the at least one update row from among the plurality of rows of the pixel array 100 during the data write period. For example, the row driving circuit 240 may not provide the write clock signals or the write enable signal to the other rows excluding the at least one update row from among the plurality of rows of the pixel array 100 during the data write period.

The data driving circuit 250 may provide the partial update data PUD received from the control logic 230, to the pixel array 100 in units of rows. Row data of the partial update data PUD may be provided to pixels PX in an enabled row in units of pixel data via the plurality of data lines DL. Accordingly, the partial update data PUD may be written to (or stored in) pixels PX in the at least one update row. For example, pixel data of update pixels corresponding to the update area from among the plurality of pixels PX of the pixel array 100 may be updated. The other pixels may retain pixel data stored in a previous frame period.

According to an embodiment, the data driving circuit 250 may provide pixel data based on the partial update data PUD to one or more update pixels from among the pixels PX of the enabled row, based on the second update area signal PAR_X received from the control logic 230. For example, the data driving circuit 250 may not provide pixel data to other pixels PX excluding the one or more update pixels from among the pixels PX of the enabled row, and may provide a mask bit that blocks update.

When the driving circuit 200 operates in a self-refresh mode (e.g., performs a self-refresh operation) according to the self-refresh command SRC, the control logic 230, the row driving circuit 240, and the data driving circuit 250 may not perform an operation for writing data to the pixel array 100 during the data write period. The row driving circuit 240 may not drive (or may disable) the plurality of rows of the pixel array 100 during the data write period.

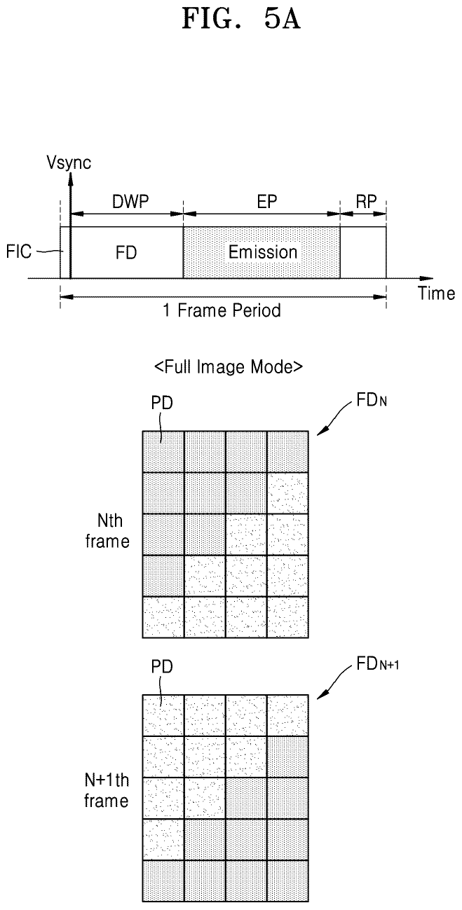

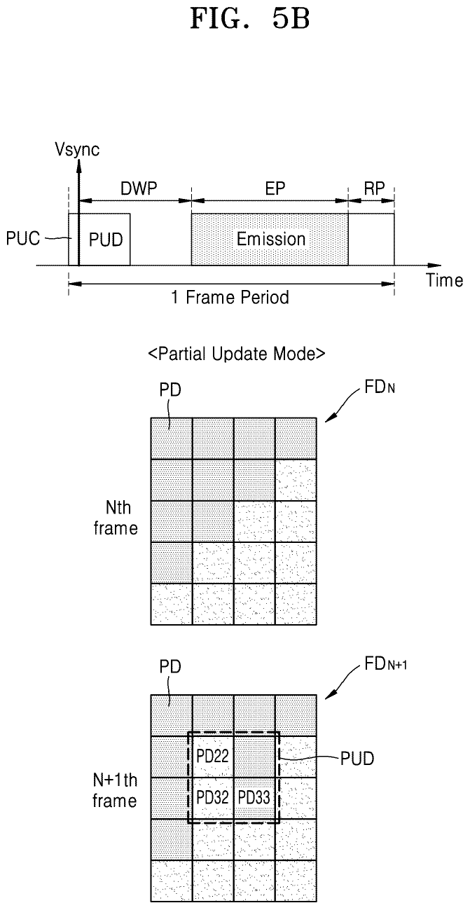

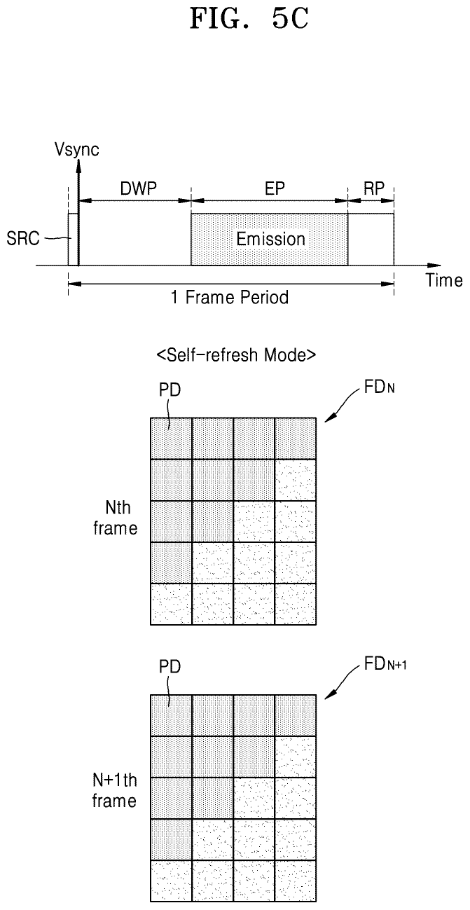

FIGS. 5A, 5B, and 5C are views illustrating operations of the display device 100 based on modes, according to example embodiments. The operations of FIGS. 5A, 5B, and 5C based on modes may be performed in the display driving circuit 11 or the driving circuit 200 of the display device 10 of FIGS. 1 and 2, and therefore, descriptions of FIGS. 1 and 2 are applicable to the present embodiment.

Referring to FIGS. 5A through 5C, the host processor 20 of FIG. 1 may compare N-th frame data FD_{N} corresponding to an image of an N-th frame displayed on the display 12 of FIG. 1 (e.g., an image of a current frame) with an (N+1)th frame data FD_{N+1} corresponding to an image of an (N+1)th frame to be displayed on the display 12 (e.g., an image of a next frame), thereby generating a command that is to be transmitted to the display device 10 of FIG. 1. The host processor 20 may transmit the vertical synchronization signal Vsync to the display device 10, and may transmit a command, such as the full image command FIC, the partial update command PUC, or the self-refresh command SRC, to the display device 10 before or after transmitting the vertical synchronization signal Vsync to the display device 10.

The display device 10 may operate in the full image mode, the partial update mode, or the self-refresh mode in units of frames, based on the vertical synchronization signal Vsync and the command received from the host processor 20. One frame period may include a data write period DWP, an emission period EP, and a rest period RP, and a length of each of the data write period DWP, the emission period EP, and the rest period RP may be the same in the full image mode, the partial update mode, and the self-refresh mode. For example, a length of the data write period DWP may be the same in each of the full image mode, the partial update mode, and the self-refresh mode. A length of the emission period EP may be the same in each of the full image mode, the partial update mode, and the self-refresh mode. A length of the rest period RP may be the same in each of the full image mode, the partial update mode, and the self-refresh mode.

As illustrated in FIG. 5A, when the entire pixel data PD is different between the N-th frame data FD_{N} and the (N+1)th frame data FD_{N+1}, or a significant portion (e.g., more than a threshold number) of the pixel data PD is different therebetween, the host processor 20 may generate the full image command FIC and transmit the same to the display device 10. The pixel data PD being different between the N-th frame data FD_{N} and the (N+1)th frame data FD_{N+1} may refer to grayscales represented by two pieces of pixel data PD at the same location in two pieces of frame data being different from each other. The host processor 20 may transmit the (N+1)th frame data FD_{N+1} as the frame data FD to the display device 10

The display device 10 may operate in the full image mode according to the full image command FIC. The display device 10 may receive the frame data FD from the host processor 20 during the data write period DWP and write (store) the frame data FD to the pixel array 100. As described above with reference to FIG. 4, the data write period DWP may include the plurality of horizontal periods HP, and the display device 10 may receive the frame data FD in units of rows (e.g., in units of row data) in each of the plurality of horizontal periods HP and write (store) the frame data FD in units of rows in the plurality of rows of the pixel array 100.

During the emission period EP, the plurality of pixels PX of the pixel array 100 may output optical signals, based on the stored pixel data PD. Accordingly, an image corresponding to the received frame data FD, for example, the (N+1)th frame data FD_{N+1}, may be displayed. During the rest period RP after the emission period EP and before the next frame period begins, the pixel array 100 may not output optical signals.

Referring to FIG. 5B, when the pixel data PD of a partial area is different between the N-th frame data FD_{N} and the (N+1)th frame data FD_{N+1}, the host processor 20 may generate the partial image command PUC and transmit the same to the display device 10.

The host processor 20 may generate partial update data PUD including pixel data PD22, PD32, and PD33 different from the N-th frame data FD_{N} among the plurality of pieces of pixel data PD of the (N+1)th frame data FD_{N+1}, and may transmit the partial update data PUD to the display device 10.

The display device 10 may operate in the partial update mode according to the partial image command PUC. During the data write period DWP, the display device 10 may receive the partial update data PUD from the host processor 20, and may write (store) the partial update data PUD to (in) pixels PX (e.g., update pixels) corresponding to a partial update area among the plurality of pixels PX of the pixel array 100 in units of pixel data, thereby updating pixel data. Accordingly, pixel data of some pixels PX among the plurality of pixels PX of the pixel array 100 may be changed, and some other pixels PX may maintain pixel data stored previously (e.g., in a previous frame period).

The display device 10 may receive the partial update data PUD in units of rows (e.g., in units of row data) in each of one or more horizontal periods among the plurality of horizontal periods HP of the data write period DWP, and may write (store) the partial update data PUD in units of rows in an update row of the plurality of rows of the pixel array 100.

As shown in FIG. 5B, the display device 10 may receive the partial update data PUD in an early part of the data write period DWP, for example, in one or more relatively earlier (preceding) horizontal periods HP among the plurality of horizontal periods HP, or may receive the partial update data PUD in at least one horizontal period HP corresponding to at least one update row of the pixel array 100 to which the partial update data PUD is to be written among the plurality of horizontal periods HP.

During the emission period EP, the plurality of pixels PX of the pixel array 100 may output optical signals, based on the stored pixel data PD. Accordingly, an image corresponding to frame data, for example, to the (N+1)th frame data FD_{N+1}, obtained by changing a portion of frame data stored in a previous frame, for example, the N-th frame data FD_{N}, to the partial update data PUD may be displayed.

Referring to FIG. 5C, when the N-th frame data FD_{N} is the same as the (N+1)th frame data FD_{N+1}, the host processor 20 may generate the self-refresh command SRC and transmit the same to the display device 10. The host processor 20 may not transmit image data to the display device 10.

The display device 10 may operate in the self-refresh mode according to the self-refresh command SRC. Because there is no image data received from the host processor 20 during the data write period DWP, the display device 10 does not perform a data write operation. During the data write period DWP, the transmission interface circuit of the host processor 20 and the reception interface circuit of the display device 10 (e.g., the interface circuit 210 of FIG. 2) may operate in a low power mode.

During the emission period EP, the plurality of pixels PX of the pixel array 100 may output optical signals, based on the stored pixel data PD. Accordingly, an image corresponding to the (N+1)th frame data, which is the same as the frame data stored in the previous frame (e.g., the N-th frame data FD_{N}) may be displayed. Accordingly, the same image may be displayed on the N-th frame and the (N+1)th frame.

When the display device 10 displays images of a plurality of frames in a plurality of frame periods, the display device 10 may operate in the full image mode according to FIG. 5A in at least one frame period, and may operate in the partial update mode according to FIG. 5B in at least one frame period. The display device 10 may operate in the self-refresh mode according to FIG. 5C during at least one frame period.

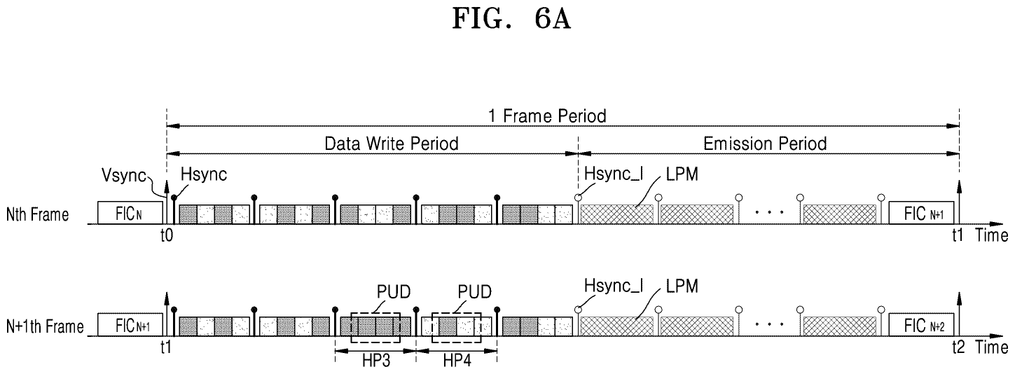

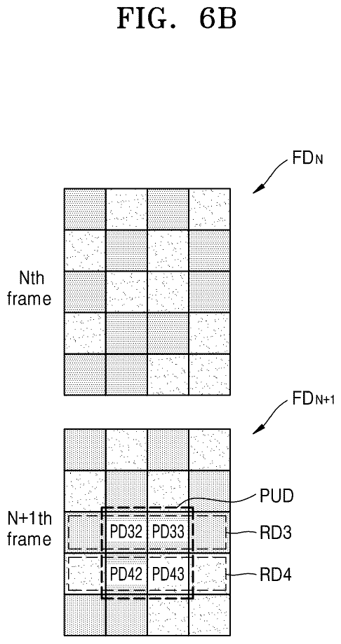

FIG. 6A illustrates a full image mode operation of the display device 10, according to an example embodiment. FIG. 6B illustrates the N-th frame data FD_{N} and the (N+1)th frame data FD_{N+1} according to an example embodiment.

The frame data, for example, the N-th frame data FD_{N} and the (N+1)th frame data FD_{N+1}, may have a size equal to the size of the pixel array 100 of FIG. 2, and the number of pieces of pixel data of the frame data and the numbers of rows and columns of the frame data may be equal to the number of pixels PX of the pixel array 100 of FIG. 2 and the numbers of rows and columns of the pixel array 100.

For convenience of explanation, it is assumed that the frame data, for example, the N-th frame data FD_{N} and the (N+1)th frame data FD_{N+1}, includes 20 pieces of pixel data PD arranged in 5 rows and 4 columns, and that the pixel array 100 includes 5 rows and 4 columns and includes 20 pixels PX.

Referring to FIG. 6A, a period from a time point t0 to a time point t1 represents an N-th frame period, and a period from a time point t1 to a time point t2 represents an (N+1)th frame period. For convenience of explanation, the N-th frame period and the (N+1)th frame period are illustrated as being located on different time axes, but the (N+1)th frame period is continuous with the N-th frame period. For example, the time point t1 of the N-th frame period may be the same as the time point t1 of the (N+1)th frame period.

The display device 10 may receive a full image command FIC_{N} for the N-th frame, and may receive the vertical synchronization signal Vsync at the time point t0. Although FIG. 6A illustrates that a command is received before the vertical synchronization signal Vsync is received, the present invention is not limited thereto, and the command may be received after the vertical synchronization signal Vsync is received.

After the vertical synchronization signal Vsync is received, the data write period may begin. During the data write period, the display device 10 may receive horizontal synchronization signals Hsync and the N-th frame data FD_{N}.

The display device 10 may sequentially receive a plurality of pieces of row data of the N-th frame data FD_{N} during a plurality of horizontal periods distinguished by the horizontal synchronization signals Hsync. The driving circuit 200 of the display device 10 may write (store) row data received in each of the plurality of horizontal periods to (in) a corresponding row of the pixel array 100.

After reception of the N-th frame data FD_{N} is completed, an emission period may begin, and, during the emission period, the display device 10 may output optical signals corresponding to the N-th frame data FD_{N} stored in the pixel array 100 to thereby display an image.

Then, the display device 10 may receive a full image command FIC_{N+1} for the (N+1)th frame, and may receive the vertical synchronization signal Vsync at the time point t1. Although the N-th frame data FD_{N} and the (N+1)th frame data FD_{N+1} are different in some pieces of pixel data PD32, PD33, and PD43, it is assumed that the display device 10 receives a full image command FIC_{N+1} for the (N+1)th frame in order to explain that the display device 10 operates in the full image mode during the (N+1)th frame period.

During the data write period, the display device 10 may receive horizontal synchronization signals Hsync, sequentially receive a plurality of pieces of row data of the (N+1)th frame data FD_{N+1} in the plurality of horizontal periods distinguished by the horizontal synchronization signals Hsync, and write (store) the row data to (in) a corresponding row of the pixel array 100.

Third row data RD3 received in a third horizontal period HP3 may include the pixel data PD32 and PD33 of the partial update area PUD, and the third row data RD3 may be written to pixels PX of a third row of the pixel array 100. Fourth row data RD4 received in a fourth horizontal period HP4 may include the pixel data PD42 and PD43 of the partial update area PUD, and may be written to pixels PX of a fourth row of the pixel array 100.

After reception of the (N+1)th frame data FD_{N+1} is completed, the display device 10 may output optical signals corresponding to the (N+1)th frame data FD_{N+1} stored in the pixel array 100 during the emission period, to thereby display an image.

According to an embodiment, after the reception of the frame data (e.g., the N-th frame data FD_{N} and the (N+1)th frame data FD_{N+1}) is completed, the transmission interface circuit of the host processor 20 and the reception interface circuit of the display device 10 (e.g., the interface circuit 210 of FIG. 2) may operate in a low power mode LPM until a command for a next frame is received. The host processor 20 may not transmit data and/or control signals, for example, a horizontal synchronization signal Hsync, to the display device 10. The clock signal generation circuit 260 of the display device 10 may generate an internal horizontal synchronization signal Hsync_I, and the driving circuit 200 may operate based on the internal horizontal synchronization signals Hsync_I. For example, during the emission period, the row drive circuit 240 may generate PWM clock signals and row control signals, based on the internal horizontal synchronization signal Hsync_I.

According to an embodiment, horizontal synchronization signals Hsync may be received from the host processor 20 even after reception of the frame data is completed, and the driving circuit 200 may operate based on the horizontal synchronization signals Hsync.

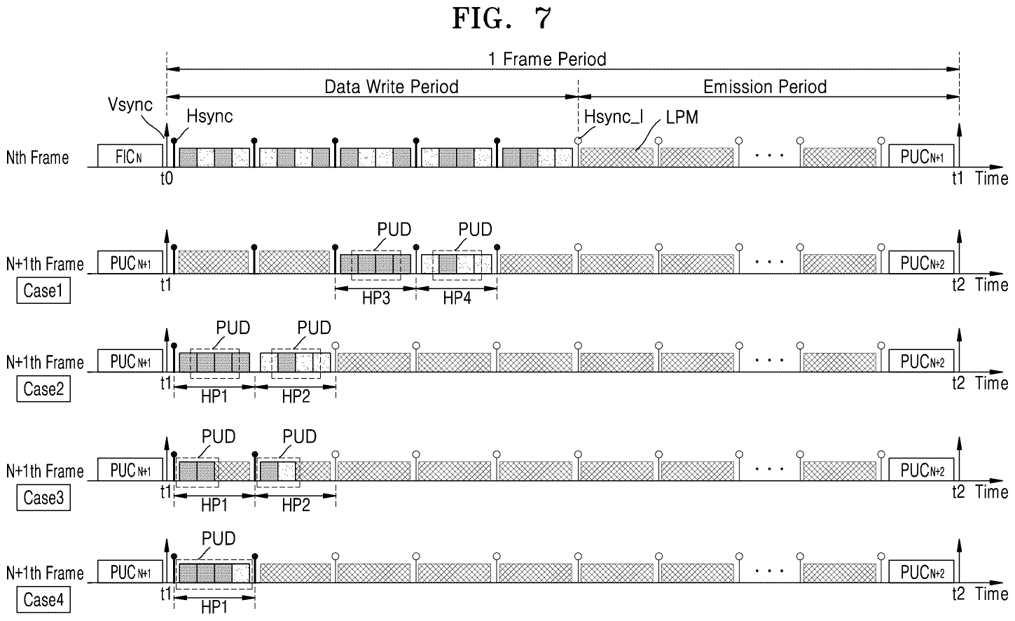

FIG. 7 illustrates a partial update mode operation of the display device 10 according to a transmission method, according to example embodiments. The reception of the partial update data PUD of the N-th frame data FD_{N} and the (N+1)th frame data FD_{N+1} illustrated in FIG. 6B will be illustrated and explained.

In FIG. 7, the display device 10 may receive the N-th frame data FD_{N} from the host processor 20 during a data write period of the N-th frame period, and may output optical signals based on the N-th frame data FD_{N} during an emission period of the N-th frame period. An operation of the N-th frame period is the same as that described above with reference to FIG. 6A, so a detailed description thereof is omitted.

Case 1 illustrates a method of receiving the partial update data PUD according to a first transmission method. The display device 10 may receive a partial update command PUC_{N+1} for the (N+1)th frame, and may receive the vertical synchronization signal Vsync at a time point t1.

After the vertical synchronization signal Vsync is received, the display device 10 may receive horizontal synchronization signals Hsync during the data write period, and may receive one or more pieces of row data including the partial update data PUD of the (N+1)th frame data FD_{N+1} during at least one horizontal period of the plurality of horizontal periods distinguished by the horizontal synchronization signals Hsync.

In FIG. 6B, the third row data RD3 and the fourth row data RD4 include the partial update data PUD. The display device 10 may receive the entirety of third row data RD3 of the (N+1)th frame data FD_{N+1} in the third horizontal period HP3 corresponding to the third row of the pixel array 100. The display device 10 may receive the entirety of fourth row data RD4 of the (N+1)th frame data FD_{N+1} in the fourth horizontal period HP4 corresponding to the fourth row of the pixel array 100.

According to an embodiment, the transmitting interface circuit of the host processor 20 and the receiving interface circuit of the display device 10 may operate in the low power mode LPM during remaining horizontal periods except for a horizontal period in which row data is received (e.g., the third horizontal period HP3 and the fourth horizontal period HP4) in the data write period.

The control logic 230 of FIG. 2 may provide a first update area signal PAR_Y indicating that the third row and the fourth row of the pixel array 100 are update rows to the row driving circuit 240 of FIG. 2, based on update area information included in the partial update command PUC_{N+1} for the (N+1)th frame, and the row driving circuit 240 of FIG. 2 may enable the third row of the pixel array 100 in the third horizontal period HP3 and enable the fourth row of the pixel array 100 in the fourth horizontal period HP4, based on the first update area signal PAR_Y.

In the third horizontal period HP3, the data driving circuit 250 of FIG. 2 may receive the third row data RD3 from the control logic 230, and may output the third row data RD3 in units of pixel data through the plurality of data lines DL. In the third horizontal period HP3, the third row data RD3 may be written to pixels PX of the enabled third row of the pixel array 100. In the fourth horizontal period HP4, the data driving circuit 250 may receive the fourth row data RD4 from the control logic 230, and may output the fourth row data RD4 through the plurality of data lines DL. In the fourth horizontal period HP4, the fourth row data RD4 may be written to pixels PX of the enabled fourth row of the pixel array 100.

According to an embodiment, the control logic 230 may provide a second update area signal PAR_X indicating that a second column and a third column of the pixel array 100 are update columns to the data driving circuit 250, based on the update area information.

In the third horizontal period HP3, the data driving circuit 250 may output the pixel data PD32 and PD33 corresponding to update pixels PX among the third row data RD3 through corresponding data lines DL (e.g., a second data line and a third data line), based on the second update area signal PAR_X. The pixel data PD32 and PD33 may be written to update pixels PX arranged in the second column and third column of the third row of the pixel array 100, respectively.

In the fourth horizontal period HP4, the data driving circuit 250 may output the pixel data PD42 and PD43 corresponding to update pixels PX among the fourth row data RD4 through corresponding data lines DL, based on the second update area signal PAR_X. The pixel data PD42 and PD43 may be written to update pixels PX arranged in the second column and third column of the fourth row of the pixel array 100, respectively.

Case 2 illustrates a method, performed by the display device 10, of receiving the partial update data PUD according to a second transmission method.

The display device 10 may receive one or more pieces of row data including the partial update data PUD of the (N+1)th frame data FD_{N+1} during one or more relatively earlier horizontal periods from among the plurality of horizontal periods distinguished by the horizontal synchronization signals Hsync in a data write period of the (N+1)th frame period.

The display device 10 may receive the entire third row data RD3 of the (N+1)th frame data FD_{N+1} in the first horizontal period HP1, and may receive the entire fourth row data RD4 of the (N+1)th frame data FD_{N+1} in the second horizontal period HP2. According to an embodiment, after reception of the partial update data PUD is completed, the transmission interface circuit of the host processor 20 and the reception interface circuit of the display device 10 may operate in the low power mode LPM.

As described above, the control logic 230 may generate the first update area signal PAR_Y, based on the update area information, and provide the first update area signal PAR_Y to the row driving circuit 240. The row driving circuit 240 may enable the third row of the pixel array 100 in the first horizontal period HP1 and enable the fourth row of the pixel array 100 in the second horizontal period HP2, based on the first update area signal PAR_Y.

In the first horizontal period HP1, the data driving circuit 250 may receive the third row data RD3 from the control logic 230, and may output the third row data RD3 in units of pixel data through the plurality of data lines DL. In the first horizontal period HP1, the third row data RD3 may be written to pixels PX of the enabled third row of the pixel array 100. In the second horizontal period HP2, the data driving circuit 250 may receive the fourth row data RD4 from the control logic 230, and may output the fourth row data RD4 through the plurality of data lines DL. In the second horizontal period HP2, the fourth row data RD4 may be written to pixels PX of the enabled fourth row of the pixel array 100.

According to an embodiment, the control logic 230 may generate the second update area signal PAR_X, based on the update area information, and provide the second update area signal PAR_X to the row driving circuit 250.

The data driving circuit 250 may provide the partial update data PUD to second and third update columns of the pixel array 100, based on the second update area signal PAR_X in the first horizontal period HP1 and the second horizontal period HP2.

The data driving circuit 250 may output the partial update data PUD through data lines DL (e.g., the second data line and the third data line) corresponding to update columns (e.g., the second column and the third column) of the pixel array 100.

Accordingly, the pixel data PD32 and PD33 may be written to the update pixels PX arranged in the second column and the third column of the third row of the pixel array 100 in the first horizontal period HP1, respectively, and the pixel data PD42 and PD43 may be written to the update pixels PX arranged in the second column and the third column of the fourth row of the pixel array 100 in the second horizontal period HP2, respectively.

Case 3 illustrates a method, performed by the display device 10, of receiving the partial update data PUD according to a third transmission method.

The display device 10 may receive the partial update data PUD of the (N+1)th frame data FD_{N+1} in units of rows during one or more relatively earlier horizontal periods from among the plurality of horizontal periods distinguished by the horizontal synchronization signals Hsync in the data write period of the (N+1)th frame period.

The display device 10 may receive the pixel data PD32 and PD33 located in the third row in the (N+1)th frame data FD_{N+1} among the partial update data PUD during the first horizontal period HP1, and may receive the pixel data PD42 and PD43 located in the fourth row in the (N+1)th frame data FD_{N+1} among the partial update data PUD during the second horizontal period HP2.

According to an embodiment, in each of the first horizontal period HP1 and the second horizontal period HP2, after transmission of the partial update data PUD is completed, the transmission interface circuit of the host processor 20 and the reception interface circuit of the display device 10 may operate in the low power mode LPM until a next horizontal period. After reception of the partial update data PUD is completed, the transmission interface circuit of the host processor 20 and the reception interface circuit of the display device 10 may operate in the low power mode LPM.

The control logic 230 may generate the first update area signal PAR_Y and the second update area signal PAR_X, based on the update area information, and may provide the first update area signal PAR_Y and the second update area signal PAR_X to the row driving circuit 240 and the data driving circuit 250, respectively.

The row driving circuit 240 may enable the third row of the pixel array 100 in the first horizontal period HP1 and enable the fourth row of the pixel array 100 in the second horizontal period HP2, based on the first update area signal PAR_Y received from the control logic 230.

As described above for Case 2, the data driving circuit 250 may provide the partial update data PUD to the second and third update columns of the pixel array 100 in the first horizontal period HP1 and the second horizontal period HP2, based on the second update area signal PAR_X received from the control logic 230.

The data driving circuit 250 may output the partial update data PUD through data lines DL (e.g., the second data line and the third data line) corresponding to update columns (e.g., the second column and the third column) of the pixel array 100.

The pixel data PD32 and PD33 may be written to the update pixels PX arranged in the second column and the third column of the third row of the pixel array 100 in the first horizontal period HP1, respectively, and the pixel data PD42 and PD43 may be written to the update pixels PX arranged in the second column and the third column of the third row of the pixel array 100 in the second horizontal period HP2, respectively.

Case 4 illustrates a method, performed by the display device 10, of receiving the partial update data PUD according to a fourth transmission method.

The display device 10 may receive the partial update data PUD of the (N+1)th frame data FD_{N+1} during one relatively earlier horizontal period from among the plurality of horizontal periods distinguished by the horizontal synchronization signals Hsync in the data write period of the (N+1)th frame period.

According to an embodiment, as illustrated in FIG. 7, the display device 10 may receive the partial update data PUD in the first horizontal period HP1, which is the earliest among the plurality of horizontal periods.

According to an embodiment, when the number of pixel data PD included in the partial update data PUD exceeds the number of pixel data PD that may be received in one horizontal period (e.g., the first horizontal period HP1), the display device 10 may receive the partial update data PUD in the plurality of horizontal periods. For example, the display device 10 may receive the partial update data PUD during the plurality of horizontal periods including the first horizontal period HP1 and one or more horizontal periods consecutive to the first horizontal period HP1.

According to an embodiment, after reception of the partial update data PUD is completed, the transmission interface circuit of the host processor 20 and the reception interface circuit of the display device 10 may operate in the low power mode LPM.

The control logic 230 may generate the first update area signal PAR_Y and the second update area signal PAR_X, based on the update area information, and may provide the first update area signal PAR_Y and the second update area signal PAR_X to the row driving circuit 240 and the data driving circuit 250, respectively.

The row driving circuit 240 may enable the third row of the pixel array 100 in the first horizontal period HP1 and enable the fourth row of the pixel array 100 in the second horizontal period HP2, based on the first update area signal PAR_Y received from the control logic 230.

According to an embodiment, the control logic 230 may include a buffer memory. A storage capacity of the buffer memory may be less than the data amount of frame data. For example, the storage capacity of the buffer memory may be less than ¼ of the data amount of frame data.

In the first horizontal period HP1, the control logic 230 may provide the pixel data PD32 and PD33 located in the third row in the (N+1)th frame data FD_{N+1} among the partial update data PUD, and may store the pixel data PD42 and PD43 located in the fourth row in the (N+1)th frame data FD_{N+1} among the partial update data PUD in an internal storage area, for example, a buffer memory. The control logic 230 may provide the pixel data PD42 and PD43 to the row driving circuit 240 during the second horizontal period HP2.

The data driving circuit 250 may provide the partial update data PUD to the second and third update columns of the pixel array 100 in the first horizontal period HP1 and the second horizontal period HP2, based on the second update area signal PAR_X received from the control logic 230.

The data driving circuit 250 may output the partial update data PUD through data lines DL (e.g., the second data line and the third data line) corresponding to update columns (e.g., the second column and the third column) of the pixel array 100.

The pixel data PD32 and PD33 may be written to the update pixels PX arranged in the second column and the third column of the third row of the pixel array 100 in the first horizontal period HP1, respectively, and the pixel data PD42 and PD43 may be written to the update pixels PX arranged in the second column and the third column of the fourth row of the pixel array 100 in the second horizontal period HP2, respectively.

As described above, the partial update data PUD may be received by the display device 10 according to various transmission methods. The transmission method of the partial update data PUD may be set between the host processor 20 and the display device 10.

According to an embodiment, at least two of the first through fourth transmission methods may be set between the host processor 20 and the display device 10, and, in the (N+1)th frame period, the host processor 20 may select one transmission method from the set at least two transmission methods. The host processor 20 may generate the partial update command PUC_{N+1} for the (N+1)th frame, and the partial update command PUC_{N+1} may include information indicating the selected transmission method. The display device 10 may determine the selected transmission method, based on the received partial update command PUCN+1, and may receive the partial update data PUD according to the selected transmission method.

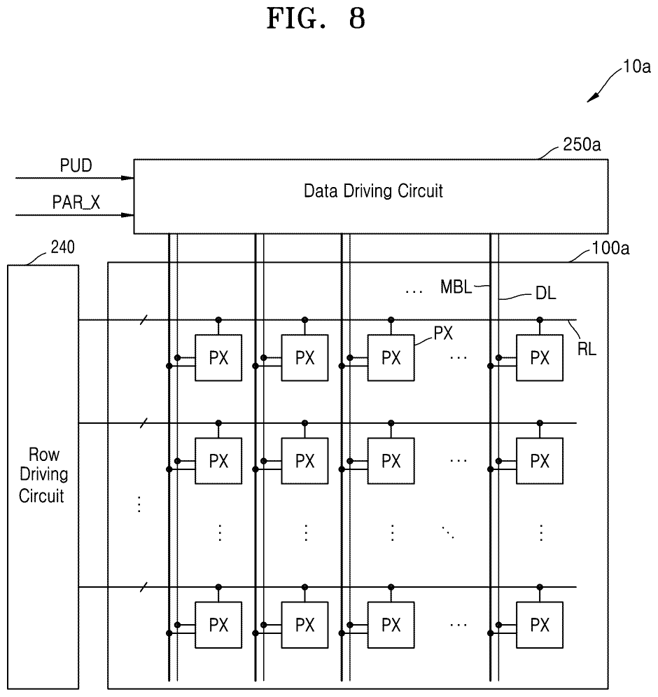

FIG. 8 is a schematic diagram of a display device 10a according to an example embodiment.

Referring to FIG. 8, the display device 10a may include a pixel array 100a, the row driving circuit 240, and a data driving circuit 250a, and may further include other components, such as the interface circuit 210, the decoder 220, the control logic 230, and the clock signal generation circuit 260 of FIG. 2. The display device 10a of FIG. 8 is a modification of the display device 10 of FIG. 2, and differences from the display device 10 of FIG. 2 will be mainly explained.

Referring to FIG. 8, the pixel array 100a may include a plurality of pixels PX arranged in a matrix, a plurality of row lines RL each extending in a row direction, a plurality of data lines DL each extending in a column direction, and a plurality of mask bit lines MBL each extending in the column direction.

A data line DL and a mask bit line MLB may be connected to pixels PX included in each of a plurality of columns of the pixel array 100a. The data driving circuit 250a may receive the partial update data PUD and the second update area signal PAR_X from the control logic 230, and may provide the partial update data PUD to at least one update column of the pixel array 100a, based on the second update area signal PAR_X.

The data driving circuit 250a may provide the partial update data PUD to one or more update columns among a plurality of columns of the pixel array 100a, based on the second update area signal PAR_X, generate a plurality of mask bits, each of which indicates whether pixel data is updated, based on the second update area signal PAR_X, and output the plurality of mask bits in units of bits through the plurality of mask bit lines MBL, thereby providing the plurality of mask bits to the plurality of columns of the pixel array 100a. For example, a mask bit at a first level (e.g., logic low) indicates an update of pixel data, and a mask bit at a second level (e.g., logic high) indicates blocking of the update of the pixel data.

For example, as illustrated in FIG. 6B, when the partial update data PUD includes the pixel data of the second column and the third column of the frame data, the second update area signal PAR_X may represent the second column and the third column of the pixel array 100a as update columns. The data driving circuit 250a may output the partial update data PUD in units of pixels through the second data line and the third data line among the plurality of data lines DL, output mask bits at the first level through the second mask bit line and the third mask bit line among the plurality of mask bit lines MBL, respectively, and output mask bits at the second level through other bit lines, respectively.

At least one update row among a plurality of rows of the pixel array 100a may be enabled, and an update pixel PX among pixels PX included in the enabled row may receive pixel data (e.g., corresponding pixel data among the partial update data PUD) received through a corresponding data line DL. For example, pixels PX arranged in the second column and the third column of the pixel array 100a may receive the partial update data PUD for each pixel through the second data line and the third data line. Each of the pixels PX included in the enabled row may receive a mask bit through a corresponding mask bit line MBL. Among the pixels PX of the enabled row, a pixel PX (e.g., an update pixel) that has received a mask bit of the first level may store the received pixel data. For example, the pixel data may be updated. Among the pixels PX of the enabled row, pixels PX (e.g., non-update pixels) that have received the mask bit of the second level do not update the pixel data. For example, the non-update pixels may retain previously stored pixel data.

As described above, the pixel array 100a may include the plurality of data lines DL and the plurality of mask bit lines MBL, and the data driving circuit 250 may provide the partial update data PUD to one or more update columns among the plurality of columns of the pixel array 100a through a corresponding data line DL, based on the second update area signal PAR_Y, and may provide a mask bit to the plurality of columns of the pixel array 100a through a corresponding mask bit line MBL. Accordingly, among the plurality of pixels PX of the pixel array 100a, update pixels may update pixel data, based on the partial update data PUD, and other pixels may be prevented from updating the pixel data, based on invalid pixel data.

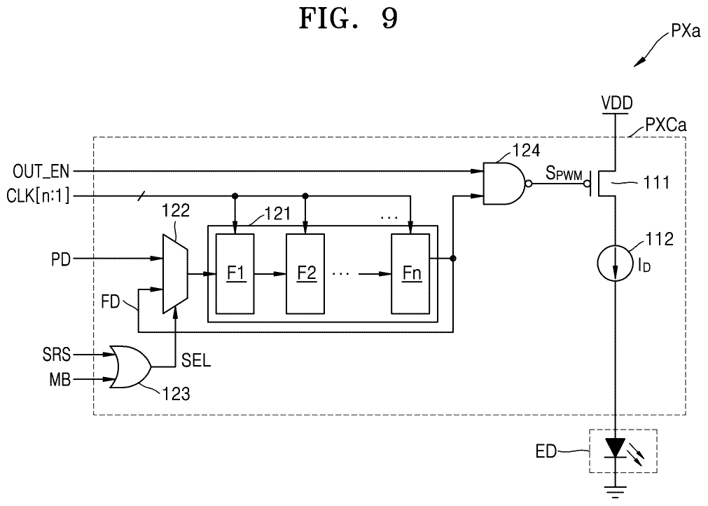

FIG. 9 illustrates a pixel PXa according to an example embodiment. The pixel PXa is applicable to the pixel PX of the pixel array 100a of FIG. 8.

Referring to FIG. 9, the pixel PXa may include a pixel circuit PXCa and an emission device ED. The pixel circuit PXCa may include a driving switch 111, a current source 112, a serial shift circuit 121, an input selector 122, a selection control circuit 123, and an output control circuit 124.

The serial shift circuit 121 may store received pixel data PD and shift the pixel data PD in units of one bit. The serial shift circuit 121 may include a plurality of storage circuits. For example, the storage circuits may be implemented as flip-flops, latches, etc. For example, the serial shift circuit 121 may include first through n-th flip-flops F1 through Fn. For example, when the pixel data PD includes 8 bits of data, the serial shift circuit 121 may include 8 flip-flops.

Each of the first through n-th flip-flops F1 through Fn may store a received bit in response to a corresponding clock signal among clock signals CLK[n:1], and output the stored bit to a next flip-flop connected to an output terminal of a previous flip-flop. During the data write period, write clock signals may be provided as the clock signals CLK[n:1] to the first through n-th flip-flops F1 through Fn, and, during the emission period, output clock signals, for example, PWM clock signals, may be provided as the clock signals CLK[n:1] to the first through n-th flip-flops F1 through Fn.

The input selector 122 may provide the pixel data PD received through the data line DL of FIG. 8 or feedback data FD received from an output terminal of the serial shift circuit 121 to an input terminal of the serial shift circuit 121. The input selector 122 may select the pixel data PD or the feedback data FD, based on a selection signal SEL received from the selection control circuit 123, and provide the pixel data PD or the feedback data FD to the serial shift circuit 121.

The selection control circuit 123 may generate the selection signal SEL, based on a mask bit MB received through the mask bit line MBL of FIG. 8 or a self-refresh signal SRS received as one of the control signals from the row driving circuit 240 of FIG. 8.

According to an embodiment, the selection control circuit 123 may be implemented as an OR gate. For example, the selection control circuit 123 may output the selection signal SEL of a second level (e.g., logic high) in response to the mask bit MB of the second level or the self-refresh signal SRS of the second level, and the input selector 122 may output the feedback data FD in response to the selection signal SEL of the second level. The selection control circuit 123 may output the selection signal SEL of a first level (e.g., logic low) in response to the mask bit MB of the first level and the self-refresh signal SRS of the first level, and the input selector 122 may output the pixel data PD in response to the selection signal SEL of the first level.

For example, when the display device 10a operates in a self-refresh mode, the row driving circuit 240 may provide the self-refresh signal SRS of the second level to the plurality of rows of the pixel array 100a during an emission period, and the pixels PX of the pixel array 100a may self-refresh pixel data stored in the serial shift circuit 121, based on the self-refresh signal SRS of the second level.

For example, when the display device 10a operates in a partial update mode, the data driving circuit 250 may provide the mask bit MB of the first level to an update pixel from among the plurality of pixels of the pixel array 100a and provide the mask bit MB of the second level to a non-update pixel from among the plurality of pixels of the pixel array 100a, during a data write period. The update pixel may store the received pixel data PD, based on the mask bit MB of the first level in the serial shift circuit 121. Accordingly, the pixel data PD of the serial shift circuit 121 may be updated. The non-update pixel may retain the pixel data stored in the serial shift circuit 121, based on the mask bit MB of the second level.

During the emission period, the pixel data PD stored in the serial shift circuit 121 may be output as a PWM signal S_{PWM}.

The output control circuit 124 may receive an output enable signal OUT_EN from the row driving circuit 240, and may receive an output bit from the serial shift circuit 121. The output control circuit 124 may output bits output from the serial shift circuit 121 as the PWM signal SPWM, based on an output enable signal OUT_EN, or block the outputting.

For example, the output control circuit 124 may be implemented as a NAND gate. However, the present invention is not limited thereto, and the output control circuit 124 may be implemented as any of other circuits, such as an AND gate and a NOR gate.

The output control circuit 124 may receive the output enable signal OUT_EN of a second level (e.g., logic high) during the emission period, and may receive the output enable signal OUT_EN of a first level (e.g., logic low) during the data write period. The output control circuit 124 may also receive the output enable signal OUT_EN of the first level during the rest period.

The output control circuit 124 may output a signal (e.g., a bit of pixel data) received from the serial shift circuit 121 or a complementary signal of the received signal, as the PWM signal SPWM, based on the output enable signal OUT_EN of the second level, during the emission period. For example, the output control circuit 124 may sequentially output a plurality of bits of the pixel data from the serial shift circuit 121 during the emission period. The output control circuit 124 may block the signal received from the serial shift circuit 121 (or the complementary signal), from being output as the PWM signal S_{PWM}, based on the output enable signal OUT_EN of the first level, during the data write period and the rest period. The output control circuit 124 may output a signal for turning off the driving switch 111 during the data write period and the rest period.

The driving switch 111, the current source 112, and the emission device ED may be connected to each other in series. A first power supply voltage VDD (e.g., a high-level power supply voltage) may be applied to one end of the driving switch 111, and one end of the driving switch 111 may be connected to one end of the current source 112. The other end of the current source 112 may be connected to one end of the emission device ED. The other end of the emission device ED may be grounded, or a second power supply voltage (e.g., a low-level power supply voltage) may be applied to the other end of the emission device ED.

The driving switch 111 may be implemented with one or more transistors, for example, a metal-oxide semiconductor field effect transistor (MOSFET). The driving switch 111 may be turned on or off in response to the PWM signal S_{PWM}.

According to an embodiment, the driving switch 111 may be implemented as a P-type MOS (PMOS) transistor as shown in FIG. 9. The driving switch 111 may be turned on in response to a low-level signal, and may be turned off in response to a high-level signal. However, the present invention is not limited thereto. According to an embodiment, the driving switch 111 may be implemented as an N-type MOS (NMOS) transistor, and the driving switch 111 may be turned on in response to a high-level signal and turned off in response to a low-level signal. It will now be described that the driving switch 111 is implemented as a PMOS.

The current source 112 may be implemented as one or more transistors. The current source 112 may generate a driving current I_{D} when the driving switch 111 is turned on.

When the driving switch 111 is turned on in response to an on level (e.g., a low level) of the PWM signal S_{PWM}, the current source 112 may generate the driving current I_{D} and provide the same to the emission device ED, and the emission device ED may emit light, based on the driving current I_{D}. When the driving switch 111 is turned off in response to an off level (e.g., a high level) of the PWM signal S_{PWM}, generation of the driving current I_{D} by the current source 112 may be blocked, and thus the emission device ED may not emit light.

During the data write period and the rest period, the driving switch 111 may be turned off based on a high-level signal received from the output control circuit 124, so that the emission device ED does not emit light. During the emission period, the emission device ED may emit light and may not emit light, in response to the on level and off level of the PWM signal S_{PWM} received from the output control circuit 124.

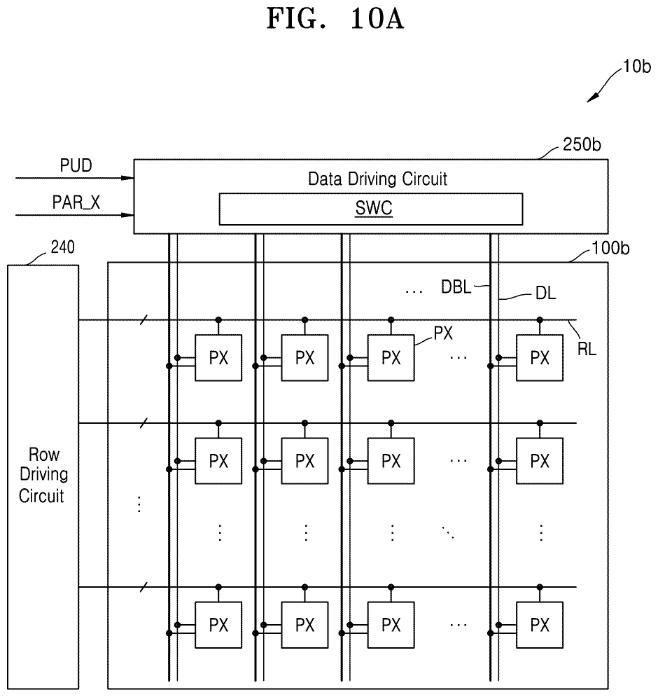

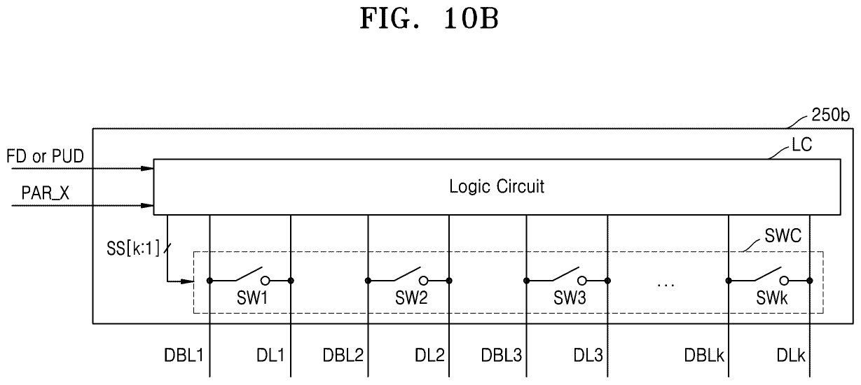

FIG. 10A illustrates a display device 10b according to an example embodiment, and FIG. 10B illustrates a data driving circuit 250b of FIG. 10A according to an example embodiment.

Referring to FIG. 10A, the display device 10b may include a pixel array 100b, the row driving circuit 240, and the data driving circuit 250b, and may further include other components, such as the interface circuit 210, the decoder 220, the control logic 230, and the clock signal generation circuit 260 of FIG. 2. The display device 10b of FIG. 10A is a modification of each of the display device 10 of FIG. 2 and the display device 10a of FIG. 8, so differences from the display devices 10 and 10a will be mainly explained.

The pixel array 100b may include a plurality of pixels PX arranged in a matrix, a plurality of row lines RL each extending in a row direction, a plurality of data lines DL each extending in a column direction, and a plurality of data bar lines DBL each extending in the column direction. A data line DL and a data bar line DBL may be connected to pixels PX included in each of a plurality of columns of the pixel array 100b.

The data driving circuit 250b may output pixel data through a data line DL, and may output complementary pixel data through a data bar line DBL. Each of a plurality of bits of the complementary pixel data may be complementary to a corresponding bit among the plurality of bits of the pixel data. For example, when the pixel data is ‘11110000’, the complementary pixel data may be ‘00001111’.

According to an embodiment, each of the data lines DL and the data bar lines DBL may be implemented as one line. The plurality of bits of the pixel data may be serially (sequentially) output via a data line DL, and the plurality of bits of the complementary pixel data may be serially (sequentially) output via a data bar line DBL. In this case, the order of the bits of the pixel data that are output through the data line DL may be the same as the order of the bits of the complementary pixel data that are output through the data bar line DBL.

According to an embodiment, each of the data lines DL and the data bar lines DBL may be implemented as a plurality of lines. The plurality of bits of the pixel data may be output via the plurality of lines of the data line DL in parallel with each other (simultaneously), and the plurality of bits of the complementary pixel data may be output via the plurality of bits of the data bar line DBL in parallel with each other (simultaneously).

A pixel PX may include a storage circuit implemented with memory circuits such as memory cells of an SRAM, and may store pixel data, based on the pixel data and the complementary pixel data received through the data line DL and the data bar line DBL.

According to an embodiment, the data driving circuit 250b may receive the partial update data PUD and the second update area signal PAR_X from the control logic 230, and may provide the partial update data PUD to at least one update column of the pixel array 100b, based on the second update area signal PAR_X. The data driving circuit 250b may generate the complementary pixel data, based on the pixel data included in the partial update data PUD. The data driving circuit 250b may provide the pixel data and the complementary pixel data of the partial update data PUD to one or more update columns among the plurality of columns of the pixel array 100b, based on the second update area signal PAR_X. The data driving circuit 250b may output the pixel data and the complementary pixel data to the data line DL and the data bar line DBL connected to the update column. At this time, the data driving circuit 250b may float the data line DL and the data bar line DBL connected to columns not updated (e.g., non-update columns) among the plurality of columns of the pixel array 100b. Pixels PX connected to the floated data line DL and the floated data bar line DBL may retain previously stored pixel data.

According to an embodiment, the data driving circuit 250b may include a switching circuit SWC. The switching circuit SWC (or an equalizing circuit) may equalize data lines DL and data bar lines DBL connected to non-update columns among the plurality of columns of the pixel array 100b. This will now be described with reference to FIG. 10B.

Referring to FIG. 10B, the data driving circuit 250b may include a logic circuit LC and the switching circuit SWC.

The logic circuit LC may temporarily store image data received in units of row data, such as, the frame data FD or the partial update data PUD, and may generate complementary pixel data for pixel data of the stored image data. The logic circuit LC may output a plurality of pieces of pixel data of the stored image data and a plurality of pieces of complementary pixel data through a plurality of data lines, for example, first through k-th data lines DL1 through DLk (where k is an integer equal to or greater than 2), and a plurality of data bar lines, for example, first through k-th data bar lines DBL1 through DBLk, respectively.

The switching circuit SWC may include a plurality of switches, for example, first through k-th switches SW1 through SWk, and the first through k-th switches SW1 through SWk may correspond to the plurality of columns of the pixel array 100b, respectively. Each of the first through k-th switches SW1 through SWk may be connected to a corresponding data line DL and a corresponding data bar line DBL among the first through k-th data lines DL1 through DLk and the first through k-th data bar lines DBL1 through DBLk. For example, the first switch SW1 may be connected to the first data line DL1 and the first data bar line DBL1. Each of the first through k-th switches SW1 through SWk may be turned on or off in response to a corresponding switch signal among a plurality of switch signals SS[k:1], and may be turned on to equalize a data line DL and a data bar line DBL connected thereto.

For example, the first switch SW1 may be turned on or turned off in response to a first switch signal SS[1], and may be turned on to electrically connect the first data line DL1 and the first data bar line DBL1, thereby equalizing the first data line DL1 and the first data bar line DBL1.

When operating in the partial update mode, the logic circuit LC may provide a switch signal toggling from an off level to an on level to switches corresponding to non-update columns among the plurality of columns of the pixel array 100b, based on the second update area signal PAR_X. The logic circuit LC may provide an off-level switch signal to one or more switches corresponding to an update column among the plurality of columns of the pixel array 100b.

For example, when a second column of the pixel array 100b is the non-update column, the second switch SW2 may receive a second switch signal SS[2] that toggles from an off level to an on level, and may be turned on according to the on level of the second switch signal SS[2]. The second switch SW2 may be turned on to equalize the second data line DL2 and the second data bar line DBL2. Then, the second switch signal SS[2] may transit to an off level, so that the second switch SWC2 may be turned off, and the second data line DL2 and the second data bar line DBL2 may float.

When a data line DL and a data bar line DBL float, pixel data may not be written to pixels PX connected to the data line DL and the data bar line DBL. However, when parasitic capacitors of the data line DL and the data bar line DBL are large, even when the data line DL and the data bar line DBL are floating, data stored in the data line DL and the data bar line DBL (e.g., invalid pixel data and invalid complementary pixel data) may be provided to a pixel PX, so that the invalid pixel data may be written to the pixel PX. The data driving circuit 250b according to an embodiment may prevent the invalid pixel data from being written to the pixel PX, by equalizing the data line DL and the data bar line DBL before the data line DL and the data bar line DBL are floated.

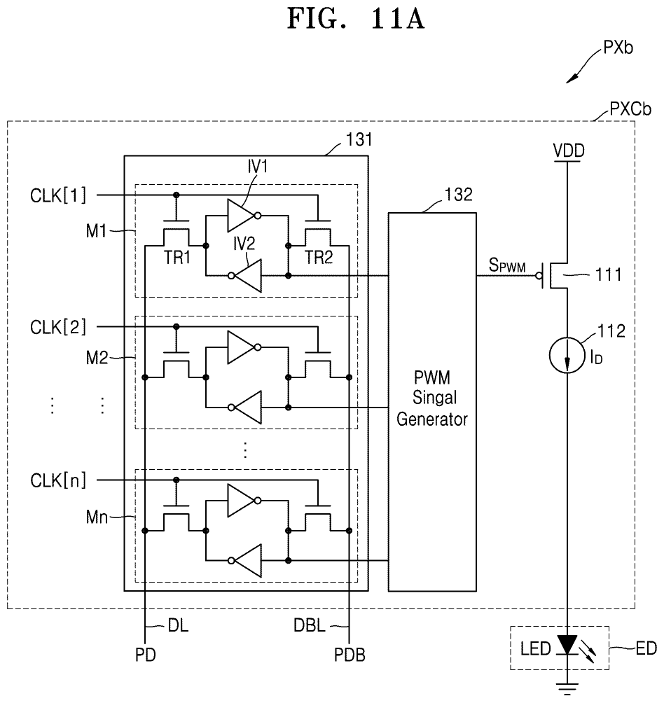

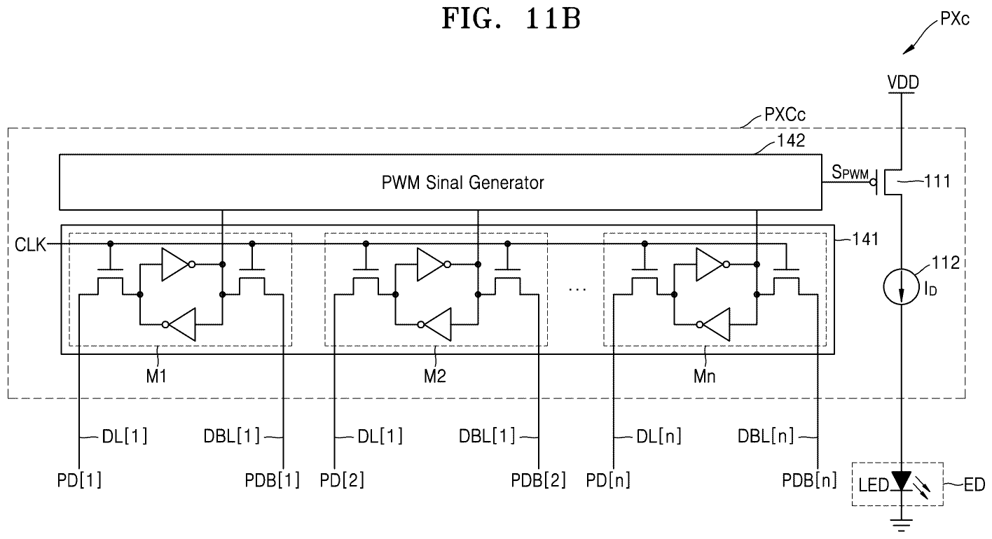

FIGS. 11A and 11B are circuit diagrams of pixels PXb and PXc according to example embodiments. The pixels PXb and PXc of FIGS. 11A and 11B are applicable to the pixels PX of the pixel array 100b of FIG. 10A.

Referring to FIG. 11A, the pixel PXb may include an emission device ED and a pixel circuit PXCb, and the pixel circuit PXCb may include the driving switch 111, the current source 112, a storage circuit 131, and a PWM signal generator 132.

The storage circuit 131 may include a plurality of memory cells each storing one bit of data, and may store pixel data PD received through a data line DL. For example, when the pixel data PD includes n bits of data, the storage circuit 131 may include n memory cells, for example, first through n-th memory cells M1 through Mn.

According to an embodiment, the storage circuit 131 may be implemented as memory cells of an SRAM. For example, each of the first through n-th memory cells M1 through Mn may include a first inverter IV1, a second inverter IV2, a first transistor TR1, and a second transistor TR2. The first transistor TRI and the second transistor TR2 may be turned on or off based on a received clock signal, and may be turned on to provide data received through a data line DL and a data bar line DBL as respective inputs of the first inverter IV1 and the second inverter IV2. Respective input terminals and respective output terminals of the first inverter IV1 and the second inverter IV2 may be connected to each other, and the first inverter IV1 and the second inverter IV2 may store one bit of data received (e.g., a corresponding bit among a plurality of bits of the pixel data PD) when the first transistor TR1 and the second transistor TR2 are turned on.

Each of the first through n-th memory cells M1 through Mn may be activated (or enabled) or deactivated (or disabled) based on a corresponding clock signal among the first through n-th clock signals CLK[n:1] (e.g., write clock signals) received from the row driving circuit 240 of FIG. 10A. The activating refers to a state in which the first transistor TR1 and the second transistor TR2 of the memory cell may be turned on to store received data. Each of the first through n-th memory cells M1 through Mn may be sequentially activated to store data received through the data line DL and the data bar line DBL, and, accordingly, the storage circuit 131 may store the pixel data PD.

The PWM signal generator 132 may generate the PWM signal S_{PWM}, based on the pixel data PD stored in the storage circuit 131, and may provide the PWM signal S_{PWM} to the driving switch 111. The PWM signal generator 132 may generate the PWM signal S_{PWM} during the emission period, and may output a signal, for example, a high-level signal, for turning off the driving switch 111 during the data write period and the rest period.

Referring to FIG. 11B, the pixel PXc may include an emission device ED and a pixel circuit PXCc, and the pixel circuit PXCc may include the driving switch 111, the current source 112, a storage circuit 141, and a PWM signal generator 142.

The storage circuit 141 may include a plurality of memory cells each storing one bit of data, for example, first through n-th memory cells M1 through Mn, and may store pixel data PD received through a data line DL. The pixel PXc may include a plurality of data lines DL[n:1] and a plurality of data bar lines DBL[n:1], and a pair of the data line DL and the data bar line DBL may be connected to a memory cell. For example, a first data line DL[1] of the data lines DL[n:1] and a first data bar line DBL[1] of the data bar lines DBL[n:1] may be connected to the first memory cell M1.

The first through n-th memory cells M1 through Mn may be simultaneously activated or deactivated based on a clock signal CLK (e.g., a write clock signal) received from the row driving circuit 240 of FIG. 10A. A plurality of bits of pixel data PD, for example, first through n-th bits PD[n:1], may be received simultaneously through the plurality of data lines DL[n:1], and a plurality of bits of complementary pixel data PDB, for example, first through n-th bits PDB[n:1], may be received simultaneously through the plurality of data bar lines DBL[n:1]. The first through n-th memory cells M1 through Mn may store the pixel data PD by receiving the pixel data PD and the complementary pixel data PDB in response to the clock signal CLK.

The PWM signal generator 142 may generate the PWM signal S_{PWM}, based on the pixel data PD stored in the storage circuit 141, and may provide the PWM signal S_{PWM} to the driving switch 111. The PWM signal generator 142 may generate the PWM signal S_{PWM} during the emission period, and may output a signal, for example, a high-level signal, for turning off the driving switch 111 during the data write period and the rest period.

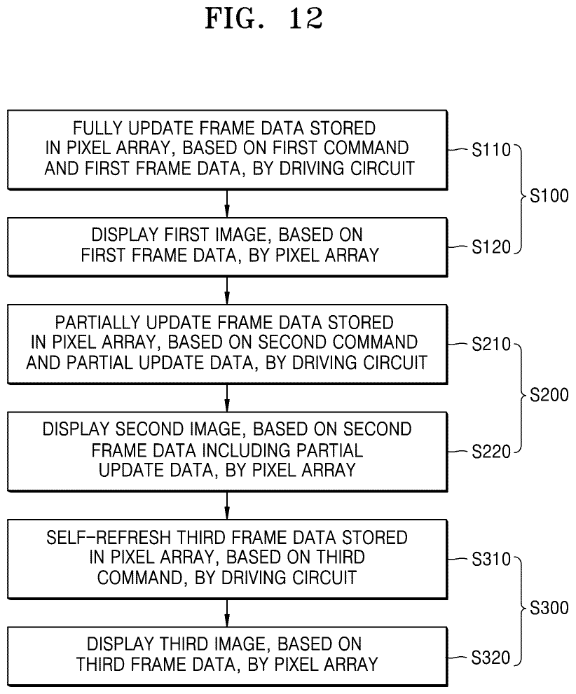

FIG. 12 is a flowchart of an operation method of a display device, according to an example embodiment. The operation method according to the inventive concept may be performed in the display devices 10, 10a, and 10b of FIGS. 1, 2, 8, 10A, and 10B.

Referring to FIG. 12, the display device may perform a full update operation S100, a partial update operation S200, and a self-refresh operation S300, based on a command and image data received from the host processor 20 of FIG. 1, and each of the full update operation S100, the partial update operation S200, and the self-refresh operation S300 may be performed in at least one frame period among a plurality of frame periods.

During a data write period of a first frame period, a driving circuit (e.g., 200 of FIG. 2) may receive a first command and first frame data from a host processor, and may fully update frame data stored in a pixel array (e.g., 100 of FIG. 2, 100a of FIG. 8, or 100b of FIG. 10A), based on the first command and the first frame data (S110). The first command may be a full image command indicating a full update. The first frame data may correspond to a first image that is to be displayed on the pixel array during the first frame period. The first frame data may be sequentially received for each row data during a plurality of horizontal periods of the data write period, and the first frame data may be sequentially written (stored) for each row data to a plurality of rows of the pixel array during the plurality of horizontal periods.

The pixel array may display the first image, based on the first frame data during an emission period of the first frame period (S120). The first image may be displayed by each of a plurality of pixels outputting an optical signal based on stored pixel data.

During a data write period of a second frame period, the driving circuit may receive a second command and partial update data from the host processor, and may partially update the frame data stored in the pixel array, based on the second command and the partial update data (S210). The second command may be a partial update command indicating a partial update. The partial update data may correspond to a portion of second frame data corresponding to a second image that is to be displayed on the pixel array during the second frame period.

The partial update data may be received during at least one horizontal period of the plurality of horizontal periods of the data write period, and the partial update data may be written to pixels PX of one or more rows of the plurality of rows of the pixel array during the at least one horizontal period. The partial update data may be written (stored) for each pixel to pixels corresponding to some areas among the plurality of pixels of the pixel array. Some other pixels may retain pixel data stored in a previous frame period.

The pixel array may display the second image, based on stored frame data, e.g., the second frame data, including the partial update data during an emission period of the second frame period (S220). The second image may differ in some areas from an image displayed in the previous frame period.

During a data write period of a third frame period, the driving circuit may receive a third command from the host processor, and may self-refresh frame data, for example, third frame data, stored in the pixel array, based on the third command (S310). The third command may be a self-refresh command indicating to maintain previously-stored frame data without updating the entirety or a portion of the frame data.

The pixel array may display a third image, based on frame data, e.g., third frame data, stored in the pixel array, during an emission period of the third frame period (S320). The third image may be the same as the image displayed in the previous frame period.

According to the present embodiment, the first frame period, the second frame period, and the third frame period are different frame periods, and each of the first frame period, the second frame period, and the third frame period corresponds to at least one frame period among a plurality of frame periods during which the display device displays an image. The first frame period, the second frame period, and the third frame period are not limited to being consecutive. For example, the third frame period may be located between the first frame period and the second frame period.

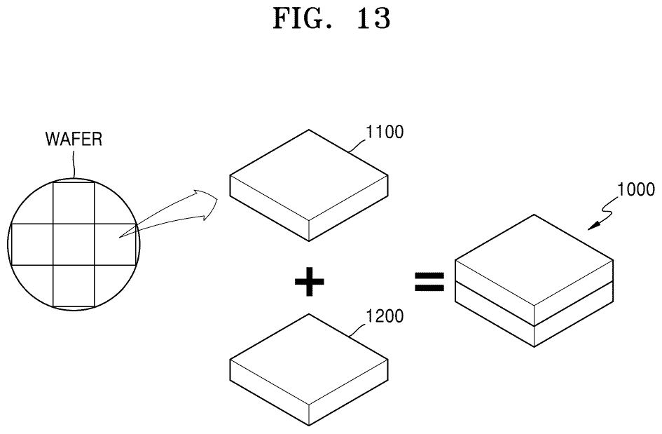

FIG. 13 is a schematic view illustrating a process of manufacturing a display device, according to an example embodiment.

Referring to FIG. 13, a display device 1000 according to an embodiment may include an emission device array 1100 and a driving circuit board 1200.

The emission device array 1100 may include a plurality of emission devices. The emission device may be an LED. The emission device may be an LED having a micro-size to a nanoscale size. For example, the size of the emission device may be 100 micrometers (um) or less. At least one emission device array 1100 may be manufactured by growing the plurality of LEDs on a growth wafer, for example, a silicon wafer, a sapphire wafer, and a GaN wafer. At least one driving circuit board 1200 may be manufactured from a semiconductor wafer, for example, a silicon wafer. Therefore, the display device 1000 may be manufactured by combining the emission device array 1100 with the driving circuit board 1200 without needing to individually transfer LEDs to the driving circuit board 1200.

Pixel circuits corresponding to respective LEDs on the emission device array 1100 may be arranged on the driving circuit board 1200, and the driving circuit (e.g., 200 of FIG. 2) may also be formed on the driving circuit board 1200. LEDs on the emission device array 1100 and the pixel circuits on the driving circuit board 1200 may be electrically connected to each other, thereby forming the pixels PX.

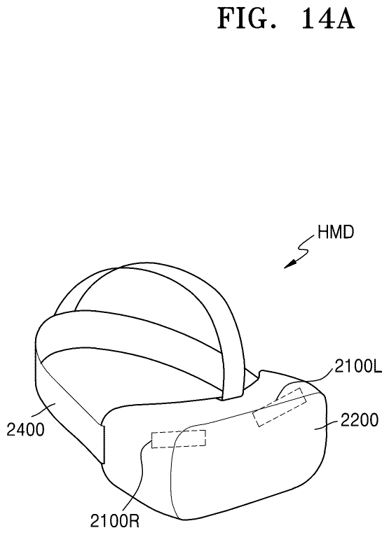

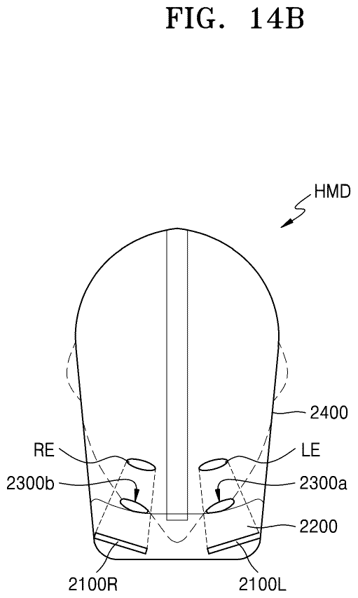

FIGS. 14A and 14B are schematic views of a head-mounted display to which a display device is applied, according to example embodiments.

Referring to FIGS. 14A and 14B, a head-mounted display HMD to which display devices 2100R and 2100L are applied, according to an embodiment, includes a display storage case 2200, a left-eye lens 2300a, a right-eye lens 2300b, and a head-mounted band 2400.

The display storage case 2200 stores the display devices 2100R and 2100L, and provides images of the display devices 2100R and 2100L to the left-eye lens 2300a and the right-eye lens 2300b. The display devices 2100R and 2100L may be the display devices (e.g., 10 of FIGS. 1 and 2, 10a of FIGS. 8, and 10b of FIG. 10A) according to an embodiment. When there is not much change between images of a plurality of frames output by the display devices 2100R and 2100L, the amount of data received by the display devices 2100R and 2100L from the host processor may be reduced, and power consumption may be reduced.

The display storage case 2200 may be designed to provide the same image to the left-eye lens 2300a and the right-eye lens 2300b. Alternatively, the display storage case 2200 may be designed so that a left-eye image may be displayed to the left-eye lens 2300a and a right-eye image may be displayed to the right-eye lens 2300b.

The left-eye display device 2100L may display the left-eye image, and the right-eye display device 2100R may display the right-eye image. Accordingly, the left-eye image displayed on the left-eye display device 2100L may be shown to a user's left eye LE through the left-eye lens 2300a, and the right-eye image displayed on the right-eye display device 2100R may be shown to the user's right eye RE through the right-eye lens 2300b.

According to an embodiment, magnifying lenses may be additionally placed between the left-eye lens 2300a and the left-eye display device 2100L and between the right-eye lens 2300b and the right-eye display device 2100R. In this case, the images displayed on the left-eye display device 2100L and the right-eye display device 2100R may appear enlarged to the user by the magnifying lenses.

According to an embodiment, the display storage case 2200 may further include a mirror reflector, and the display devices 2100L and 2200R may be positioned above the display storage case 2200 to display an image in a direction toward the mirror reflector, and the mirror reflector may totally reflect the received image in directions toward the left-eye lens 2300a and the right-eye lens 2300b. Accordingly, the images displayed on the display devices 2100L and 2200R may be provided to the left-eye lens 2300a and the right-eye lens 2300b.

The structures of FIGS. 14A and 14B are applicable to VR, AR, and MR apparatuses.

The inventive concept has been particularly shown and described with reference to exemplary embodiments thereof. The terminology used herein is for the purpose of describing exemplary embodiments only and is not intended to be limiting of the inventive concept. Therefore, it will be understood by those skilled in the art that various changes in form and details may be made therein without departing from the spirit and scope of the present invention as defined by the appended claims.

What is claimed is:

1. A display driving circuit comprising:
a pixel circuit array including a plurality of pixel circuits arranged in a matrix, each of the plurality of pixel circuits configured to store pixel data and provide a driving current corresponding to the pixel data to an emission device;
an interface circuit configured to receive a partial update command and partial update data from a host processor;
a control logic configured to generate a first update area signal indicating at least one update row including update pixel circuits to which the pixel data is to be updated from among a plurality of rows of the pixel circuit array, based on update area information included in the partial update command;
a row driving circuit configured to provide write clock signals to first pixel circuits included in the at least one update row of the pixel circuit array, based on the first update area signal; and
a data driving circuit configured to provide update pixel data to each of the update pixel circuits from among the first pixel circuits, based on the partial update data.

2. The display driving circuit of claim 1, wherein during a data write period in one frame period:
the interface circuit is configured to receive the partial update data, and the data driving circuit is configured to provide the update pixel data to each of the update pixel circuits, based on the partial update data.

3. The display driving circuit of claim 2, wherein:
the interface circuit is configured to receive row data corresponding to the at least one update row in at least one horizontal period corresponding to the at least one update row among a plurality of horizontal periods included in the data write period, and the row data includes pixel data corresponding to each of non-update pixel circuits from among the first pixel circuits and the partial update data.

4. The display driving circuit of claim 2, wherein:
the interface circuit is configured to receive row data corresponding to the at least one update row, and the row data includes the partial update data in at least one horizontal period that is relatively earlier from among a plurality of horizontal periods included in the data write period.

5. The display driving circuit of claim 4, wherein the row data includes pixel data corresponding to each of non-updated pixel circuits among the first pixel circuits and the partial update data.

6. The display driving circuit of claim 4, wherein the row data includes the partial update data except for pixel data corresponding to non-updated pixel circuits among the first pixel circuits.

7. The display driving circuit of claim 6, wherein:
the partial update data corresponds to two or more update rows of the pixel circuit array, and the partial update data is received in units of rows during two or more relatively preceding horizontal periods among the plurality of horizontal periods.

8. The display driving circuit of claim 6, wherein:
the partial update data corresponds to two or more update rows of the pixel circuit array, and first update data corresponding to at least two update rows among the partial update data is received during the most preceding horizontal period among the plurality of horizontal periods.

9. The display driving circuit of claim 1, wherein the control logic is further configured to:
generate a second update area signal indicating at least one column including the update pixel circuits from among a plurality of columns of the pixel circuit array, based on the update area information, and provide the second update area signal to the data driving circuit.

10. The display driving circuit of claim 9, wherein:
the pixel circuit array further includes a plurality of mask bit lines each extending in a column direction and electrically connected to the plurality of pixel circuits, and the data driving circuit is configured to provide a mask bit indicating whether the pixel data is updated to each of the plurality of pixel circuits through the plurality of mask bit lines.

11. The display driving circuit of claim 10, wherein each of the plurality of pixel circuits includes a serial shift circuit configured to store the pixel data and sequentially output a plurality of bits of the pixel data.

12. The display driving circuit of claim 9, wherein:
the pixel circuit array further includes a plurality of first data lines and a plurality of second data lines each extending in a column direction and electrically connected to the plurality of pixel circuits, and a second pixel data provided to one second data line of the plurality of second data lines is a complementary pixel data of a first pixel data provided to a corresponding one first data line of the plurality of first data lines.

13. The display driving circuit of claim 12, wherein each of the plurality of pixel circuits includes a memory cell configured to receive the first and second pixel data, and store the first pixel data.

14. The display driving circuit of claim 1, wherein the emission device includes a light- emitting diode (LED) having a size of the LED being 100 micrometers (um) or less.

15. A display driving circuit for driving a pixel array that displays an image, the display driving circuit comprising:
an interface circuit configured to receive commands and image data from a host processor, receive a first command of the commands and first frame data corresponding to a first image of one frame of the image data in a first frame period, and receive a second command of the commands and partial update data corresponding to a partial area of a second image of one frame of the image data in a second frame period;
a row driving circuit configured to enable at least one update row from among a plurality of rows of the pixel array during a data write period of the second frame period; and
a data driving circuit configured to provide the partial update data to at least one update column from among a plurality of columns of the pixel array, based on the partial update data during the data write period of the second frame period.

16. The display driving circuit of claim 15, wherein:
the interface circuit is configured to receive the partial update data during at least one horizontal period from among a plurality of horizontal periods in the data write period of the second frame period, and the row driving circuit is configured to enable the at least one update row during the at least one horizontal period.

17. The display driving circuit of claim 15, wherein, during a data write period of the first frame period:
the row driving circuit is configured to sequentially enable a plurality of rows of the pixel array, and the data driving circuit is configured to provide the first frame data to the plurality of columns of the pixel array.

18. The display driving circuit of claim 15, wherein:
the interface circuit is configured to receive a third command of the commands from the host processor during a third frame period, and the row driving circuit is configured to disable the plurality of rows of the pixel array during a data write period of the third frame period.

19. An operation method of a display driving circuit for driving a pixel array that displays an image, the operation method comprising:
fully updating frame data stored in the pixel array with first frame data corresponding to a first image, based on a first command received from a host processor and the first frame data, during a data write period of a first frame period; and
partially updating frame data stored in the pixel array with partial update data, based on a second command received from the host processor and the partial update data, during a data write period of a second frame period, wherein the partially updating of the frame data comprises:
receiving the partial update data in at least one horizontal period from among a plurality of horizontal periods in the data write period of the second frame period; and
writing the partial update data to at least one update row of a plurality of rows of the pixel array during the at least one horizontal period.

20. The operation method of claim 19, further comprising:
self-refreshing frame data stored in the pixel array, based on a third command received from the host processor during a data write period of a third frame period.
